(19) United States
(12) Patent Application Publication
(10) Pub. No.: US 2022/0263225 A1
(43) Pub. Date: Aug. 18, 2022

(54) ANTENNA MODULE AND ELECTRONIC DEVICE

(71) Applicant: GUANGDONG OPPO MOBILE TELECOMMUNICATIONS CORP., LTD., Dongguan (CN)

(72) Inventor: Yuhu JIA, Dongguan (CN)

(21) Appl. No.: 17/733,468

(22) Filed: Apr. 29, 2022

Related U.S. Application Data
(63) Continuation of application No. PCT/CN2020/122827, filed on Oct. 22, 2020.

(30) Foreign Application Priority Data
Oct. 31, 2019 (CN) 201911063649.7

(51) Int. Cl. H01Q 1/22; H01Q 1/38; H01Q 9/04

(52) U.S. Cl. CPC H01Q 1/2283; H01Q 9/0414; H01Q 1/38

(57) ABSTRACT

An antenna module and an electronic device are provided in the present disclosure. The antenna module includes a first antenna radiator, a first parasitic radiator, a second antenna radiator, and a second parasitic radiator. The first antenna radiator is configured to generate a first resonance in a first frequency band range. The first parasitic radiator is stacked with and spaced apart from the first antenna radiator. The first parasitic radiator is capable of coupling with the first antenna radiator to generate a second resonance in the first frequency band range. The second antenna radiator is configured to generate a first resonance in a second frequency band range. The second parasitic radiator is capable of coupling with the second antenna radiator to generate a second resonance in the second frequency band range. The second frequency band range is at least partially not overlapped with the first frequency band range.

### CROSS-REFERENCE TO RELATED APPLICATIONS

This application is a continuation of International Application No. PCT/CN2020/122827, filed Oct. 22, 2020, which claims priority to Chinese Patent Application No. 201911063649.7, filed Oct. 31, 2019, the entire disclosures of which are incorporated herein by reference.

### TECHNICAL FIELD

This disclosure relates to the field of electronic devices, and in particular to an antenna module and an electronic device.

### BACKGROUND

With development of mobile communication technology, the 4th-generation (4G) mobile communication can no longer meet people's requirements. The 5th-generation (5G) mobile communication is favored by users because of its high communication speed. For example, a data transmission speed in the 5G mobile communication is hundreds of times faster than that in the 4G mobile communication. The 5G mobile communication is mainly implemented via millimeter wave (mmWave) signals when an mmWave antenna is applied to an electronic device.

### SUMMARY

An antenna module is provided in the present disclosure. The antenna module includes a first antenna radiator, a first parasitic radiator, a second antenna radiator, and a second parasitic radiator. The first antenna radiator is configured to generate a first resonance in a first frequency band range. The first parasitic radiator is stacked with and spaced apart from the first antenna radiator. The first parasitic radiator is capable of coupling with the first antenna radiator to generate a second resonance in the first frequency band range. The second antenna radiator is stacked with and spaced apart from the first antenna radiator at a side of the first antenna radiator away from the first parasitic radiator. The second antenna radiator is configured to generate a first resonance in a second frequency band range. The second parasitic radiator is stacked with and spaced apart from the second antenna radiator or disposed at the same layer as and spaced apart from the second antenna radiator. The second parasitic radiator is capable of coupling with the second antenna radiator to generate a second resonance in the second frequency band range. The second frequency band range is at least partially not overlapped with the first frequency band range.

An electronic device is further provided in the present disclosure. The electronic device includes a controller and the above-mentioned antenna module. The controller is electrically connected with the antenna module, and the antenna module is configured to operate under control of the controller.

### BRIEF DESCRIPTION OF THE DRAWINGS

In order to describe technical solutions of implementations of the present disclosure more clearly, the following will give a brief introduction to the accompanying drawings used for describing the implementations. Apparently, the accompanying drawings hereinafter described are merely some implementations of the present disclosure. Based on these drawings, those of ordinary skill in the art can also obtain other drawings without creative effort.

FIG. 1 is a schematic perspective structural view of an antenna module provided in an implementation of the present disclosure.

FIG. 2 is a schematic view of part of a package of an antenna module provided in an implementation of the present disclosure.

FIG. 3 is a schematic cross-sectional structural view taken along line I-I in FIG. 2 in an implementation of the present disclosure.

FIG. 4 is a schematic cross-sectional structural view taken along line I-I in FIG. 2 in another implementation of the present disclosure.

FIG. 5 is a top view of a first parasitic radiator in an antenna module provided in an implementation of the present disclosure.

FIG. 6 is a top view of a first antenna radiator in an antenna module provided in an implementation of the present disclosure.

FIG. 7 is a schematic cross-sectional view taken along line II-II in FIG. 2 in an implementation of the present disclosure.

FIG. 8 is a top view of a first antenna radiator and a first parasitic radiator in an antenna module provided in an implementation of the present disclosure.

FIG. 9 is a top view of a first antenna radiator and a first parasitic radiator in an antenna module provided in another implementation of the present disclosure.

FIG. 10 is a top view of a first parasitic radiator in an antenna module provided in an implementation of the present disclosure.

FIG. 11 is a top view of a first antenna radiator in an antenna module provided in an implementation of the present disclosure.

FIG. 12 is a schematic cross-sectional view taken along line III-III in FIG. 10.

FIG. 13 is a top view of a first parasitic radiator in an antenna module provided in an implementation of the present disclosure.

FIG. 14 is a top view of a first antenna radiator in an antenna module provided in an implementation of the present disclosure.

FIG. 15 is a schematic cross-sectional view taken along line Iv-Iv in FIG. 13.

FIG. 16 is a top view of a second antenna radiator and a second parasitic radiator in an antenna module provided in an implementation of the present disclosure.

FIG. 17 is a top view of a first antenna radiator and a first parasitic radiator in an antenna module provided in an implementation of the present disclosure.

FIG. 18 is a top view of a first antenna radiator provided in an implementation of the present disclosure.

FIG. 19 is a top view of a second antenna radiator provided in an implementation of the present disclosure.

FIG. 20 is a cross-sectional view of an antenna module provided in an implementation of the present disclosure.

FIG. 21 is a schematic diagram illustrating a size of a first antenna radiator and a size of a first parasitic radiator provided in an implementation of the present disclosure.

FIG. 22 illustrates variation curves of return loss with frequency of an optimized antenna module provided in an implementation of the present disclosure.

FIG. 23 is a top view of a second antenna radiator and a second parasitic radiator.

FIG. 24 is a schematic view of an antenna module provided in an implementation of the present disclosure.

FIG. 25 is a schematic view of an antenna module provided in another implementation of the present disclosure.

FIG. 26 is a schematic diagram illustrating radiation efficiency of an RF signal of 24 GHz˜30 GHz radiated by an antenna module of the present disclosure.

FIG. 27 is a schematic diagram illustrating radiation efficiency of an RF signal of 36 GHz˜41 GHz radiated by an antenna module of the present disclosure.

FIG. 28 is a directional simulation pattern of an antenna module at 26 GHz of the present disclosure.

FIG. 29 is a directional simulation pattern of an antenna module at 28 GHz of the present disclosure.

FIG. 30 is a directional simulation pattern of an antenna module at 39 GHz of the present disclosure.

FIG. 31 is a circuit block diagram of an electronic device provided in an implementation of the present disclosure.

FIG. 32 is a cross-sectional view of an electronic device provided in an implementation of the present disclosure.

FIG. 33 is a cross-sectional view of an electronic device provided in another implementation of the present disclosure.

### DETAILED DESCRIPTION

In the implementations of the present disclosure, terms such as “center”, “longitudinal”, “lateral”, “length”, “width”, “thickness”, “on”, “under”, “front”, “back”, “left”, “right”, “vertical”, “horizontal”, “top”, “bottom”, “in”, “out”, “axial”, “radial”, “circumferential”, and the like referred to herein which indicate directional relationship or positional relationship are directional relationship or positional relationship based on accompanying drawings and are only for the convenience of description and simplicity, rather than explicitly or implicitly indicate that apparatuses or components referred to herein must have a certain direction or be configured or operated in a certain direction and therefore cannot be understood as limitation on the disclosure.

In addition, terms “first”, “second”, and the like are only used for description and cannot be understood as explicitly or implicitly indicating relative importance or implicitly indicating the number of technical features referred to herein. Therefore, features restricted by terms “first”, “second”, and the like can explicitly or implicitly include at least one of the features. In the context of the disclosure, unless stated otherwise, “multiple” refers to “at least two”, such as two, three, and the like.

Unless stated otherwise, in the disclosure, terms “installing”, “coupling”, “connecting”, “fixing”, and the like referred to herein should be understood in broader sense. For example, coupling may be a fixed coupling, a removable coupling, or an integrated coupling, may be a mechanical coupling, an electrical coupling, and may be a direct coupling, an indirect coupling through a medium, or a communication coupling between two components or an interaction coupling between two components, unless stated otherwise. For those of ordinary skill in the art, the above terms in the present disclosure can be understood according to specific situations.

An antenna module is provided in the present disclosure. The antenna module includes a first antenna radiator, a first parasitic radiator, a second antenna radiator, and a second parasitic radiator. The first antenna radiator is configured to generate a first resonance in a first frequency band range. The first parasitic radiator is stacked with and spaced apart from the first antenna radiator. The first parasitic radiator is capable of coupling with the first antenna radiator to generate a second resonance in the first frequency band range. The second antenna radiator is stacked with and spaced apart from the first antenna radiator at a side of the first antenna radiator away from the first parasitic radiator. The second antenna radiator is configured to generate a first resonance in a second frequency band range. The second parasitic radiator is stacked with and spaced apart from the second antenna radiator or disposed at the same layer as and spaced apart from the second antenna radiator. The second parasitic radiator is capable of coupling with the second antenna radiator to generate a second resonance in the second frequency band range. The second frequency band range is at least partially not overlapped with the first frequency band range.

In an implementation, the first resonance of the first antenna radiator in the first frequency band range is used to generate a radio frequency (RF) signal in a first preset frequency band. The second resonance of the first parasitic radiator in the first frequency band range is used to generate an RF signal in a second preset frequency band. The first preset frequency band and the second preset frequency band are in the first frequency band range. The first preset frequency band is at least partially different from the second preset frequency band.

In an implementation, the antenna module further includes an RF chip. The first antenna radiator is between the RF chip and the first parasitic radiator. The first antenna radiator and the first parasitic radiator are conductive patches. The first antenna radiator is electrically connected with the RF chip.

In an implementation, a size of the first antenna radiator is larger than a size of the first parasitic radiator. An orthographic projection of the first parasitic radiator on a plane where the first antenna radiator is located is at least partially overlapped with a region where the first antenna radiator is located.

In an implementation, the orthographic projection of the first parasitic radiator on the plane where the first antenna radiator is located falls into the region where the first antenna radiator is located.

In an implementation, the first antenna radiator defines a first hollow structure penetrating two opposite surfaces of the first antenna radiator. A size of the first antenna radiator is smaller than or equal to a size of the first parasitic radiator. A size difference between the first antenna radiator and the first parasitic radiator increases as an area of the first hollow structure increases.

In an implementation, the first antenna radiator defines a first hollow structure penetrating two opposite surfaces of the first antenna radiator. The first parasitic radiator defines a second hollow structure penetrating two opposite surfaces of the first parasitic radiator. A size of the first antenna radiator is smaller than or equal to a size of the first parasitic radiator. An area of the first hollow structure is larger than an area of the second hollow structure.

In an implementation, the second antenna radiator is electrically connected with the RF chip, and the second antenna radiator and the second parasitic radiator are conductive patches. The second antenna radiator is closer to the RF chip than the second parasitic radiator in case that the second parasitic radiator is stacked with and spaced apart from the second antenna radiator.

In an implementation, the first antenna radiator and the second antenna radiator are conductive patches. The second antenna radiator is closer to the RF chip than the first antenna radiator. A frequency of an RF signal in the second frequency band range is lower than a frequency of an RF signal in the first frequency band range.

In an implementation, the antenna module further includes a feeder. The second antenna radiator defines a through hole therein. The feeder extends through the through hole and electrically connects the RF chip with the first antenna radiator.

In an implementation, the second parasitic radiator is implemented as a plurality of second parasitic radiators. A center of a region where the second antenna radiator is located coincides with a center of an orthogonal projection of the plurality of second parasitic radiators on a plane where the second antenna radiator is located.

In an implementation, the second parasitic radiator is a rectangular conductive patch and has a first side facing the second antenna radiator and a second side connected with the first side. A length of the first side is larger than a length of the second side. The first side is used to adjust a resonant frequency of the second parasitic radiator. The second side is used to adjust an impedance between the second parasitic radiator and the second antenna radiator.

In an implementation, the first resonance of the second antenna radiator in the second frequency band range is used to generate an RF signal in a third preset frequency band. The second resonance of the second parasitic radiator in the second frequency band range is used to generate an RF signal in a fourth preset frequency band. The third preset frequency band and the fourth preset frequency band are in the second frequency band range. The third preset frequency band is at least partially different from the fourth preset frequency band.

In an implementation, the first antenna radiator is a square conductive patch and has a side length ranged from 1.6 mm to 2.0 mm. The first parasitic radiator is a rectangular conductive patch. A length of a long side of the first parasitic radiator is equal to the side length of the first antenna radiator. A length of a short side of the first parasitic radiator ranges from 0.2 mm to 0.9 mm. A distance between the first parasitic radiator and the first antenna radiator ranges from 0 to 0.8 mm.

In an implementation, the second antenna radiator is a square conductive patch and has a side length ranged from 2.0 mm to 2.8 mm. The second parasitic radiator is a rectangular conducive patch. A length of a long side of the second parasitic radiator is equal to the side length of the second antenna radiator. A length of a short side of the second parasitic radiator ranges from 0.2 mm to 0.9 mm. A distance between the second parasitic radiator to the second antenna radiator ranges from 0 to 0.6 mm.

In an implementation, a gap between a projection of the second parasitic radiator on a plane perpendicular to a plane where the second antenna radiator is located and a region where the second antenna radiator is located ranges from 0.2 mm to 0.8 mm.

In an implementation, the first frequency band range includes millimeter wave (mmwave) 39 GHz frequency band, and the first resonance and the second resonance in the first frequency band range cover frequency band n260. The second frequency band range includes 28 GHz, and the first resonance and the second resonance in the second frequency band range cover mmwave frequency bands n257, n258, and n261.

An electronic device is further provided in the present disclosure. The electronic device includes a controller and an antenna module of any of foregoing implementations. The controller is electrically connected with the antenna module. The antenna module is configured to operate under control of the controller.

In an implementation, the electronic device includes a battery cover and a radio-wave transparent structure carried on the battery cover. A radiation surface of the antenna module at least partially faces the battery cover and the radio-wave transparent structure. A transmittance of the battery cover to an RF signal in the first frequency band range is less than a transmittance of the battery cover and the radio-wave transparent structure to the RF signal in the first frequency band range. A transmittance of the battery cover to an RF signal in the second frequency band range is less than a transmittance of the battery cover and the radio-wave transparent structure to the RF signal in the second frequency band range.

In an implementation, the electronic device includes a screen and a radio-wave transparent structure carried on the screen. A radiation surface of the antenna module at least partially faces the screen and the radio-wave transparent structure. A transmittance of the screen to an RF signal in the first frequency band range is less than a transmittance of the screen and the radio-wave transparent structure to the RF signal in the first frequency band range. A transmittance of the screen to an RF signal in the second frequency band range is less than a transmittance of the screen and the radio-wave transparent structure to the RF signal in the second frequency band range.

Technical solutions of implementations of the present disclosure will be described clearly and completely with reference to accompanying drawings in the implementations of the present disclosure below. Apparently, the implementations described herein are merely some rather than all implementations of the present disclosure. Based on the implementations of the present disclosure, all other implementations obtained by those of ordinary skill in the art without creative effort shall fall within the protection scope of the disclosure.

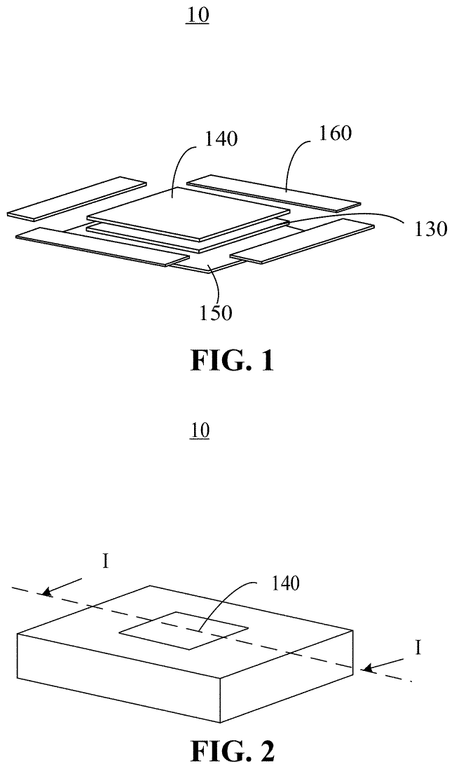

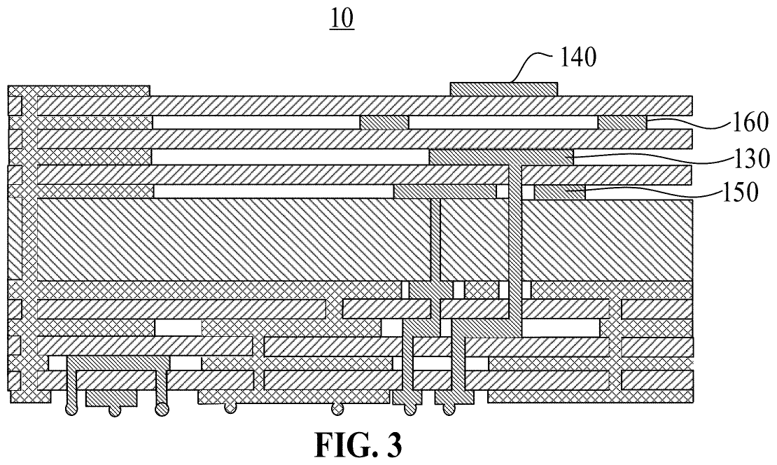

Illustrations can be made to FIGS. 1-3, FIG. 1 is a schematic perspective structural view of an antenna module provided in an implementation of the present disclosure, FIG. 2 is a schematic view of part of a package of an antenna module provided in an implementation of the present disclosure, and FIG. 3 is a schematic cross-sectional structural view taken along line I-I in FIG. 2 in an implementation of the present disclosure. An antenna module 10 is provided in the present disclosure. The antenna module 10 includes a first antenna radiator 130, a first parasitic radiator 140, a second antenna radiator 150, and a second parasitic radiator 160. The first antenna radiator 130 is configured to generate a first resonance in a first frequency band range. The first parasitic radiator 140 is stacked with and spaced apart from the first antenna radiator 130. The first parasitic radiator 140 is capable of coupling with the first antenna radiator 130 to generate a second resonance in the first frequency band range. The second antenna radiator 150 is stacked with and spaced apart from the first antenna radiator 130 at a side of the first antenna radiator 130 away from the first parasitic radiator 140. The second antenna radiator 150 is configured to generate a first resonance in a second frequency band range. The second parasitic radiator 160 is stacked with and spaced apart from the second antenna radiator 150 or disposed at the same layer as and spaced apart from the second antenna radiator 150. The second parasitic radiator 160 is capable of coupling with the second antenna radiator 150 to generate a second resonance in the second frequency band range. The second frequency band range is at least partially not overlapped with the first frequency band range.

In some implementations, as illustrated in FIG. 1, an orthographic projection of the first antenna radiator 130 on a plane where the second antenna radiator 150 is located is at least partially overlapped with the second antenna radiator 150, and the first antenna radiator 130 is spaced apart from the second antenna radiator 150. It is noted that, in the implementations of the present disclosure, the first frequency band range may also refer to a first frequency range, and the second frequency band range may also refer to a second frequency range.

The first frequency band range and the second frequency band range may include, but is not limited to, an mmWave frequency band or a terahertz (THz) frequency band. Currently, in the 5th generation (5G) wireless systems, according to the 3rd generation partnership project (3GPP) technical specification (TS) 38.101 protocol, 5G new radio (NR) mainly uses two frequency bands: a frequency range 1 (FR1) band and a frequency range 2 (FR2) band. The FR1 band has a frequency range of 450 megahertz (MHz)˜6 gigahertz (GHz), and is also known as the sub-6 GHz band. The FR2 band has a frequency range of 24.25 GHz˜52.6 GHz, and belongs to the mmWave frequency band. The 3GPP Release 15 specifies that the present 5G mmWave frequency bands include: n257 (26.5˜29.5 GHz), n258 (24.25˜27.5 GHz), n261 (27.5˜28.35 GHz), and n260 (37˜40 GHz). In some implementations, the first frequency band range can include mmwave 39 GHz frequency band, and the first resonance and the second resonance in the first frequency band range can meet transmission and reception requirements of RF signals in mmwave frequency band n260 (37˜40 GHz). The second frequency band range can include mmwave 28 GHz frequency band. The first resonance and the second resonance in the second frequency band range can satisfy transmission and reception requirements of RF signals in mmwave frequency bands n257 (26.5˜29.5 GHz), n258 (24.25˜27.5 GHz), and n261 (27.5˜28.35 GHz).

In the antenna module 10 of the present disclosure, the first antenna radiator 130 and the first parasitic radiator 140 each generate a resonance in the first frequency band range, and the second antenna radiator 150 and the second parasitic radiator 160 each generate a resonance in the second frequency band range, so that the antenna module 10 operates in two frequency bands, which expands a bandwidth of the antenna module 10. The first parasitic radiator 140 is stacked with and spaced apart from the first antenna radiator 130, so that a space in a stacking direction (Z direction) of the first parasitic radiator 140 and the first antenna radiator 130 is utilized, and sizes of the first parasitic radiator 140 and the first antenna radiator 130 on a plane (X direction and Y direction) perpendicular to the stacking direction are reduced. Correspondingly, the second parasitic radiator 160 is stacked with and spaced apart from the second antenna radiator 150, so that a space in a stacking direction (Z direction) of the second parasitic radiator 160 and the second antenna radiator 150 is utilized, and sizes of the second parasitic radiator 160 and the second antenna radiator 150 on a plane (X direction and Y direction) perpendicular to the stacking direction are reduced.

The first antenna radiator 130 may be made of a metallic conductive material or a non-metallic conductive material. In case that the first antenna radiator 130 is made of the non-metallic conductive material, the first antenna radiator 130 may be non-transparent or transparent. The first parasitic radiator 140 may be made of a metallic conductive material or a non-metallic conductive material. In case that the first parasitic radiator 140 is made of the non-metallic conductive material, the first parasitic radiator 140 may be non-transparent or transparent. Correspondingly, the second antenna radiator 150 may be made of, but not limited to, a metallic conductive material or a non-metallic conductive material. In case that the second antenna radiator 150 is made of the non-metallic conductive material, the second antenna radiator 150 may be non-transparent or transparent. The second parasitic radiator 160 may be made of a metallic conductive material or a non-metallic conductive material. In case that the second parasitic radiator 160 is made of the non-metallic material, the second parasitic radiator 160 may be non-transparent or transparent. The first antenna radiator 130, the first parasitic radiator 140, the second antenna radiator 150, and the second parasitic radiator 160 may be made of the same material or different materials.

In some implementations, the first resonance of the first antenna radiator 130 in the first frequency band range is used to generate an RF signal in a first preset frequency band. The second resonance of the first parasitic radiator 140 in the first frequency band range is used to generate an RF signal in a second preset frequency band. The first preset frequency band and the second preset frequency band are in the first frequency band range. The first preset frequency band is at least partially different from the second preset frequency band. Correspondingly, the first resonance of the second antenna radiator 150 in the second frequency band range is used to generate an RF signal in a third preset frequency band. The second resonance of the second parasitic radiator 160 in the second frequency band range is used to generate an RF signal in a fourth preset frequency band. The third preset frequency band and the fourth preset frequency band are in the second frequency band range. The third preset frequency band is at least partially different from the fourth preset frequency band.

The RF signal generated by the first resonance and the RF signal generated by the second resonance in the first frequency band range are taken as an example. Since the RF signal in the first preset frequency band and the RF signal in the second preset frequency band both belong to the first frequency band range, and the first preset frequency band is at least partially different from the second preset frequency band, the first frequency band range can meet a relatively wide bandwidth. Specifically, the first frequency band range is (P1˜P2), the first preset frequency band is (P1˜P3), and the second preset frequency band is (P4˜P2), where P3≤P2, P4≥P1, and the first preset frequency band is not equal to the second preset frequency band. P3 may be less than P4, and in this case, the first preset frequency band is non-overlapped with the second preset frequency band. P3 may be greater than or equal to P4, and in this case, the first preset frequency band is overlapped with the second preset frequency band, that is, the first preset frequency band and the second preset frequency band constitute a first frequency band which has a continuous range of frequencies. For example, the first frequency band is band n260 (37˜40 GHz), the first preset frequency band is 37 GHz˜A GHz, and the second preset frequency band is B GHz˜40 GHz, where A≤40, and 37≤B≤40. A may be less than B, and in this case, the first preset frequency band is not overlapped with the second preset frequency band. A may be greater than or equal to B, and in this case, the first preset frequency band is overlapped with the second preset frequency band, that is, the first preset frequency band and the second preset frequency band constitute a complete band n260.

Compared with the related art, the antenna module 10 of the present disclosure can radiate the RF signal in the first frequency band range and the RF signal in the second frequency band range, so that the antenna module 10 has a communication capability for RF signals in two frequency bands and achieves a relatively wide bandwidth coverage. The first antenna radiator 130 can radiate the RF signal in the first preset frequency band, and the first parasitic radiator 140 is coupled with the first antenna radiator 130 to generate the RF signal in the second preset frequency band. If the first preset frequency band is not overlapped with the second preset frequency band, a bandwidth of the antenna module 10 in the first frequency band range can be widened. If the first preset frequency band is overlapped with the second preset frequency band, radiation efficiency of the antenna module 10 in the first frequency band range can be improved. In addition, the first parasitic radiator 140 is stacked with and spaced apart from the first antenna radiator 130, and a space of the antenna module 10 in the stacking direction of the first parasitic radiator 140 and the first antenna radiator 130 can be utilized, to reduce sizes of the first parasitic radiator 140 and the first antenna radiator 130 on a plane perpendicular to the stacking direction. Correspondingly, the second antenna radiator 150 can radiate the RF signal in the third preset frequency band, and the second parasitic radiator 160 is coupled with the second antenna radiator 150 to generate the RF signal in the fourth preset frequency band. If the third preset frequency band is not overlapped with the fourth preset frequency band, a bandwidth of the antenna module 10 in the second frequency band range can be widened. If the third preset frequency band is overlapped with the fourth preset frequency band, radiation efficiency of the antenna module 10 in the second frequency band range can be improved. In addition, when the second parasitic radiator 160 is stacked with and spaced apart from the second antenna radiator 150, a space of the antenna module 10 in the stacking direction of the second parasitic radiator 160 and the second antenna radiator 150 can be utilized, to reduce sizes of the second parasitic radiator 160 and the second antenna radiator 150 on a plane perpendicular to the stacking direction.

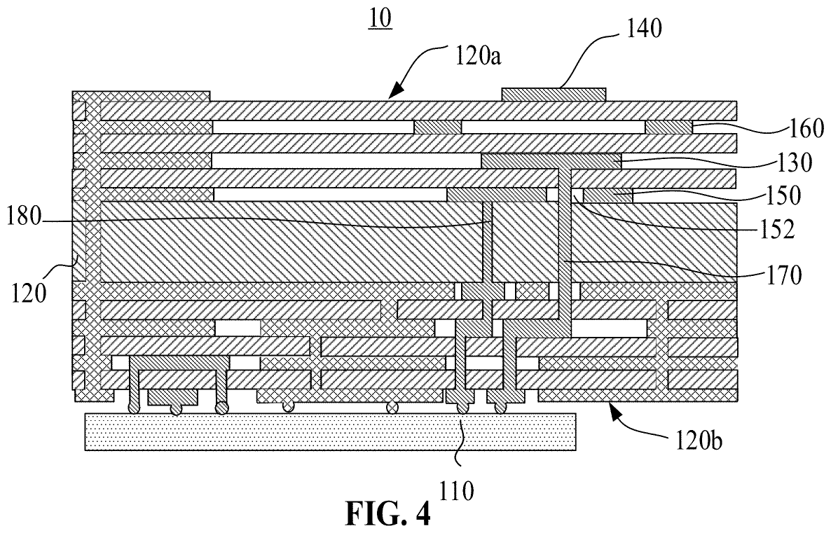

Illustrations can be made to FIG. 4, which is a schematic cross-sectional structural view taken along line I-I in FIG. 2 in another implementation of the present disclosure. The antenna module 10 further includes an RF chip 110. The first antenna radiator 130 is closer to the RF chip 110 than the first parasitic radiator 140. That is, the first antenna radiator 130 is between the RF chip 110 and the first parasitic radiator 140. The first antenna radiator 130 and the first parasitic radiator 140 are conductive patches.

The RF chip 110 is configured to generate a first excitation signal. The RF chip 110 is electrically coupled with the first antenna radiator 130 to transmit the first excitation signal to the first antenna radiator 130. The first antenna radiator 130 generates the first resonance in the first frequency band range according to the first excitation signal. In some implementations, the first antenna radiator 130 and the first parasitic radiator 140 are conductive patches. It can be understood that the first antenna radiator 130 and the first parasitic radiator 140 may also be microstrip lines, conductive silver paste, or the like.

When a distance between the first parasitic radiator 140 and the RF chip 110 is constant, if the first antenna radiator 130 is disposed farther away from the RF chip 110 than the first parasitic radiator 140, a distance between the first antenna radiator 130 and the RF chip 110 is denoted as a first distance; if the first antenna radiator 130 is disposed closer to the RF chip 110 than the first parasitic radiator 140, the distance between the first antenna radiator 130 and the RF chip 110 is denoted as a second distance, the second distance is smaller than the first distance. It can be seen that, the first antenna radiator 130 is disposed closer to the RF chip 110 than the first parasitic radiator 140, which can reduce the length of a feeder (such as a feeding wire, a feeding probe, etc.) between the first antenna radiator 130 and the RF chip 110, reduce a loss of the first excitation signal when transmitted to the first antenna radiator 130 due to an excessive length of the feeder between the first antenna radiator 130 and the RF chip 110, and increase a gain of the RF signal in the first preset frequency band generated by the first antenna radiator 130.

In addition, a size of the first antenna radiator 130 is larger than a size of the first parasitic radiator 140, and the first antenna radiator 130 is closer to the RF chip 110 than the first parasitic radiator 140, which is possible to avoid weak radiation intensity or even shielding of the RF signal in the first preset frequency band generated by the first antenna radiator 130 due to blocking of the first parasitic radiator 140.

The antenna module 10 further includes a substrate 120, the substrate 120 is used for carrying the first antenna radiator 130, the first parasitic radiator 140, and the RF chip 110. The substrate 120 has a first surface 120a and a second surface 120b opposite to the first surface 120a. In this implementation, the first parasitic radiator 140 is disposed on the first surface 120a, the first antenna radiator 130 is embedded in the substrate 120, and the RF chip 110 is disposed on the second surface 120b. The RF chip 110 is configured to generate the first excitation signal. The RF chip 110 is electrically connected with the first antenna radiator 130 via a first feeder 170 embedded in the substrate 120. It can be understood that in other implementations, the first parasitic radiator 140 and the first antenna radiator 130 can also be embedded in the substrate 120, as long as the first parasitic radiator 140 is stacked with and spaced apart from the first antenna radiator 130, and the first parasitic radiator 140 is farther away from the RF chip 110 than the first antenna radiator 130. The RF chip 110 may be fixed on the second surface 120b of the substrate 120 by welding or the like. The first feeder 170 may be, but is not limited to, a feeding wire, a feeding probe, or the like.

In some implementations, a pin of the RF chip 110 for outputting the first excitation signal is disposed on a surface of the RF chip 110 facing the substrate 120. The pin of the RF chip 110 for outputting the first excitation signal is arranged in such a way that the first feeder 170 has a relatively short length, which in turn reduces the loss of the first excitation signal when transmitted to the first antenna radiator 130 due to an excessive length of the feeder between the first antenna radiator 130 and the RF chip 110, and increases the gain of the RF signal in the first preset frequency band generated by the first antenna radiator 130.

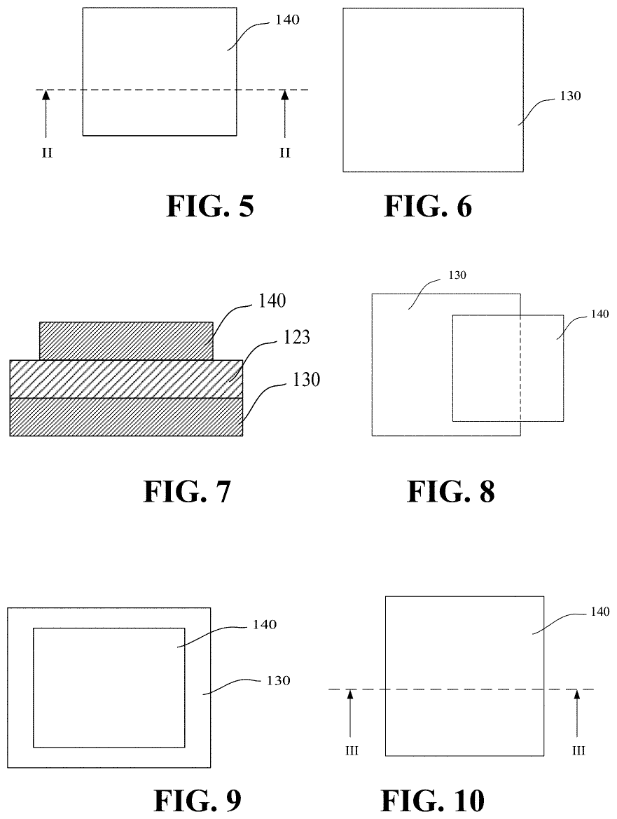

Illustrations can be made to FIGS. 5-7, FIG. 5 is a top view of a first parasitic radiator in an antenna module provided in an implementation of the present disclosure, FIG. 6 is a top view of a first antenna radiator in an antenna module provided in an implementation of the present disclosure, and FIG. 7 is a schematic cross-sectional view taken along line II-II in FIG. 2 in an implementation of the present disclosure. A shape of the first antenna radiator 130 can be, but is not limited to, rectangle, circle, polygon, and the like. Correspondingly, a shape of the first parasitic radiator 140 may be, but is not limited to, rectangle, circle, polygon, and the like. A shape of the first parasitic radiator 140 may be the same as or different from that of the first antenna radiator 130. In this implementation, for example, the first antenna radiator 130 and the first parasitic radiator 140 each are square. Since the first antenna radiator 130 is stacked with and spaced apart from the first parasitic radiator 140, one or more insulating layers 123 can be disposed between the first parasitic radiator 140 and the first antenna radiator 130. As illustrated in FIG. 7, for example, one insulating layer 123 is disposed between the first antenna radiator 130 and the first parasitic radiator 140 and other components in the antenna module 10 are omitted.

Illustrations can be made to FIG. 8 and FIG. 9, FIG. 8 is a top view of a first antenna radiator and a first parasitic radiator in an antenna module provided in an implementation of the present disclosure, and FIG. 9 is a top view of a first antenna radiator and a first parasitic radiator in an antenna module provided in another implementation of the present disclosure. A size of the first antenna radiator 130 is larger than a size of the first parasitic radiator 140. An orthographic projection of the first parasitic radiator 140 on a plane where the first antenna radiator 130 is located is at least partially overlapped with a region where the first antenna radiator 130 is located.

The orthographic projection of the first parasitic radiator 140 on the plane where the first antenna radiator 130 is located being at least partially overlapped with the region where the first antenna radiator 130 is located includes the following. The orthographic projection of the first parasitic radiator 140 on the plane where the first antenna radiator 130 is located is partially overlapped with the region where the first antenna radiator 130 is located, and the orthographic projection of the first parasitic radiator 140 on the plane where the first antenna radiator 130 is located is partially not overlapped with the region where the first antenna radiator 130 is located (illustrating in FIG. 8). In other words, part of the orthographic projection of the first parasitic radiator 140 on the plane where the first antenna radiator 130 is located falls into the region where the first antenna radiator 130 is located, and the rest of the orthographic projection of the first parasitic radiator 140 on the plane where the first antenna radiator 130 is located falls outside the region where the first antenna radiator 130 is located.

The orthographic projection of the first parasitic radiator 140 on the plane where the first antenna radiator 130 is located being at least partially overlapped with the region where the first antenna radiator 130 is located further includes the following. The orthographic projection of the first parasitic radiator 140 on the plane where the first antenna radiator 130 is located falls into the region where the first antenna radiator 130 is located.

The orthographic projection of the first parasitic radiator 140 on the plane where the first antenna radiator 130 is located is at least partially overlapped with the region where the first antenna radiator 130 is located, which can improve the coupling effect between the first parasitic radiator 140 and the first antenna radiator 130, increase a strength of the RF signal in the second preset frequency band generated by the coupling between the first parasitic radiator 140 and the first antenna radiator 130, and improve communication quality of the antenna module 10. The orthographic projection of the first parasitic radiator 140 on the plane where the first antenna radiator 130 is located falls into the region where the first antenna radiator 130 is located, which can improve the coupling effect between the first parasitic radiator 140 and the first antenna radiator 130 can be further improved, increase the strength of the RF signal in the second preset frequency band generated by the coupling between the first parasitic radiator 140 and the first antenna radiator 130, and further improve the communication quality of the antenna module 10.

In some implementations, the orthographic projection of the first parasitic radiator 140 on the plane where the first antenna radiator 130 is located falls into the region where the first antenna radiator 130 is located, and the center of the orthographic projection of the first parasitic radiator 140 on the plane where the first antenna radiator 130 is located completely coincides with the center of the region where the first antenna radiator 130 is located (illustrating in FIG. 9). As such, the coupling effect between the first parasitic radiator 140 and the first antenna radiator 130 can be further improved, the strength of the RF signal in the second preset frequency band generated by the coupling between the first parasitic radiator 140 and the first antenna radiator 130 can be further increased, and the communication quality of the antenna module 10 can be further improved.

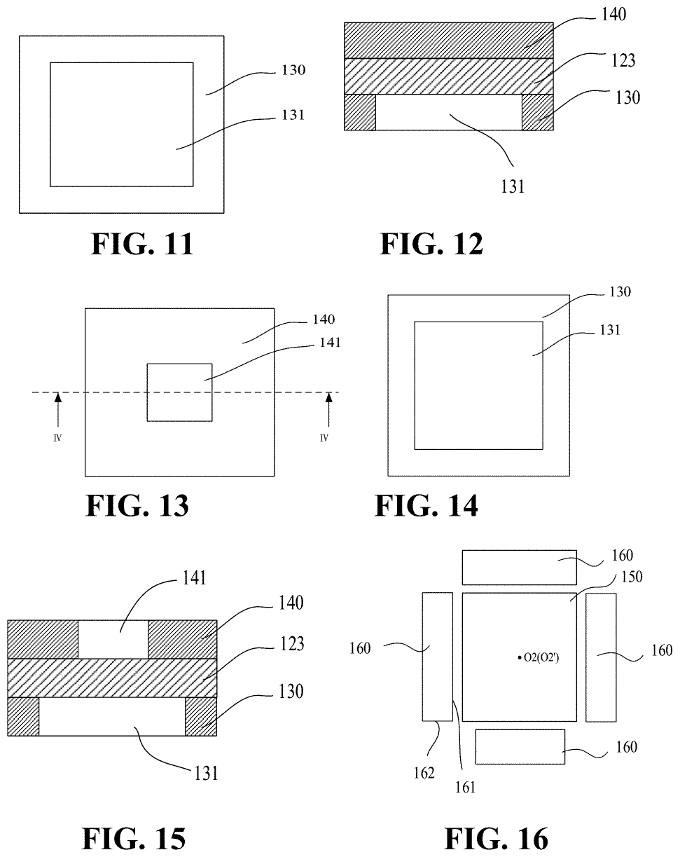

Illustrations can be made to FIGS. 10-12, FIG. 10 is a top view of a first parasitic radiator in an antenna module provided in an implementation of the present disclosure, FIG. 11 is a top view of a first antenna radiator in an antenna module provided in an implementation of the present disclosure, and FIG. 12 is a schematic cross-sectional view taken along line III-III in FIG. 10. In this implementation, the antenna module 10 further includes an RF chip 110 (illustrating in FIG. 4), the first antenna radiator 130 is closer to the RF chip 110 than the first parasitic radiator 140 and defines a first hollow structure 131 penetrating two opposite surfaces of the first antenna radiator 130. A size of the first antenna radiator 130 is smaller than or equal to a size of the first parasitic radiator 140, and a size difference between the first antenna radiator 130 and the first parasitic radiator 140 increases as an area of the first hollow structure 131 increases. In another implementation, the size of the first antenna radiator 130 may be larger than the size of the first parasitic radiator 140, and the size difference between the first antenna radiator 130 and the first parasitic radiator 140 increases as the area of the first hollow structure 131 increases. In the schematic view of this implementation, for example, the size of the first antenna radiator 130 is equal to the size of the first parasitic radiator 140. It can be understood that, one or more insulating layers 123 can be disposed between the first antenna radiator 130 and the first parasitic radiator 140. In this implementation, for example, one insulating layer 123 is disposed between the first antenna radiator 130 and the first parasitic radiator 140 and other components in the antenna module 10 are omitted.

The size of the first antenna radiator 130 generally refers to an outline size of the first antenna radiator 130, and the size of the first parasitic radiator 140 generally refers to an outline size of the first antenna radiator 130. When the first antenna radiator 130 is in the same shape as the first parasitic radiator 140 and the outline size of the first antenna radiator 130 is smaller than or equal to the outline size of the first parasitic radiator 140, a side length of the first antenna radiator 130 is also smaller than or equal to the outline size of the first parasitic radiator 140. In an implementation, when the first antenna radiator 130 is in the same shape as the first parasitic radiator 140 and the outline size of the first antenna radiator 130 is larger than the outline size of the first parasitic radiator 140, the side length of the first antenna radiator 130 is also larger than the outline size of the first parasitic radiator 140. In this implementation, for example, the first antenna radiator 130 is square, the first parasitic radiator 140 is square, the outline size of the first antenna radiator 130 is equal to the outline size of the first parasitic radiator 140, and the first hollow structure 131 is square.

For radiating the same RF signal in the first preset frequency band, compared with the first antenna radiator 130 without the first hollow structure 131, when the first excitation signal is loaded, a surface current distribution of the first antenna radiator 130 with the first hollow structure 131 in this implementation is different from a surface current distribution of the first antenna radiator 130 without the first hollow structure 131. Therefore, for radiating the same RF signal in the first preset frequency band, the outline size of the first antenna radiator 130 with the first hollow structure 131 are smaller than the outline size of the first antenna radiator 130 without the first hollow structure 131, which facilitates miniaturization of the antenna module 10.

Illustrations can be made to FIGS. 13-15, FIG. 13 is a top view of a first parasitic radiator in an antenna module provided in an implementation of the present disclosure, FIG. 14 is a top view of a first antenna radiator in an antenna module provided in an implementation of the present disclosure, and FIG. 15 is a schematic cross-sectional view taken along line Iv-Iv in FIG. 13. The antenna module 10 further includes an RF chip 110 (illustrating in FIG. 4). The first antenna radiator 130 is closer to the RF chip 110 than the first parasitic radiator 140 and has a first hollow structure 131 penetrating two opposite surfaces of the first antenna radiator 130. The first parasitic radiator 140 has a second hollow structure 141 penetrating two opposite surfaces of the first parasitic radiator 140. A size of the first antenna radiator 130 is smaller than or equal to a size of the first parasitic radiator 140, and an area of the first hollow structure 131 is larger than that of the second hollow structure 141. In another implementation, the size of the first antenna radiator 130 is larger than or equal to the size of the first parasitic radiator 140, and the area of the first hollow structure 131 is larger than that of the second hollow structure 141. In the schematic view of this implementation, for example, the size of the first antenna radiator 130 is equal to the size of the first parasitic radiator 140. In this implementation, FIG. 14 is illustrated at the same view angle as FIG. 13. A shape of an outer contour of the first antenna radiator 130 can be, but is not limited to, rectangle, circle, polygon, and the like. Correspondingly, a shape of the first parasitic radiator 140 can also be, but is not limited to, rectangle, circle, polygon, and the like. A shape of the first hollow structure 131 can also be, but is not limited to, rectangle, circle, polygon, and the like. Correspondingly, a shape of an outer contour of the second hollow structure 141 can also be, but is not limited to, rectangle, circle, polygon, and the like. The shape of the first antenna radiator 130 may be the same as or different from that of the first parasitic radiator 140.

It can be understood that, one or more insulating layers 123 can be disposed between the first antenna radiator 130 and the first parasitic radiator 140. In this implementation, for example, one insulating layer 123 is disposed between the first antenna radiator 130 and the first parasitic radiator 140 and other components in the antenna module 10 are omitted.

Correspondingly, for radiating the same RF signal in the second preset frequency band, compared with the first parasitic radiator 140 without the second hollow structure 141, when the first excitation signal is loaded, a surface current distribution of the first parasitic radiator 140 with the second hollow structure 141 in this implementation is different from a surface current distribution of the first parasitic radiator 140 without the second hollow structure 141. Therefore, for radiating the same RF signal in the second preset frequency band, the outline size of the first parasitic radiator 140 with the second hollow structure 141 are smaller than the outline size of the first parasitic radiator 140 without the second hollow structure 141, which facilitates miniaturization of the antenna module 10.

Illustrating in FIG. 4 again, the antenna module 10 further includes the RF chip 110. The second antenna radiator 150 and the second parasitic radiator 160 are conductive patches. When the second parasitic radiator 160 is stacked with and spaced apart from the second antenna radiator 150, the second antenna radiator 150 is closer to the RF chip 110 than the second parasitic radiator 160. The RF chip 110 is configured to generate a second excitation signal. The RF chip 110 is electrically coupled with the second antenna radiator 150 to transmit the second excitation signal to the second antenna radiator 150. The second antenna radiator 150 generates the second resonance in the second frequency band range according to the second excitation signal. When a distance between the second parasitic radiator 160 and the RF chip 110 is constant, if the second antenna radiator 150 is disposed farther away from the RF chip 110 than the second parasitic radiator 160, a distance between the second antenna radiator 150 and the RF chip 110 is denoted as a third distance; if the second antenna radiator 150 is closer to the RF chip 110 than the second parasitic radiator 160, the distance between the second antenna radiator 150 and the RF chip 110 is denoted as a fourth distance. As a result, the fourth distance is smaller than the third distance. It can be seen that, the second antenna radiator 150 is disposed closer to the RF chip 110 than the second parasitic radiator 160, which can reduce a length of a feeder (such as a feeding wire, a feeding probe, etc.) between the second antenna radiator 150 and the RF chip 110, reduce a loss of the second excitation signal when transmitted to the second antenna radiator 150 due to an excessive length of the feeder between the second antenna radiator 150 and the RF chip 110, and increase a gain of the RF signal in the third preset frequency band generated by the second antenna radiator 150.

In addition, for the second antenna radiator 150 and the second parasitic radiator 160 in a form of conductive patches, a size of the second antenna radiator 150 is larger than a size of the second parasitic radiator 160, and the second antenna radiator 150 is disposed closer to the RF chip 110 than the second parasitic radiator 160, which is possible to avoid weak radiation intensity or even shielding of the RF signal in the second preset frequency band generated by the second antenna radiator 150 due to blocking of the second parasitic radiator 160. Therefore, in this implementation, the arrangement of the second antenna radiator 150 and the second parasitic radiator 160 can improve the communication effect of the antenna module 10.

Illustrations can be made to FIG. 16, which is a top view of a second antenna radiator and a second parasitic radiator in an antenna module provided in an implementation of the present disclosure. The second parasitic radiator 160 is implemented as multiple second parasitic radiators 160. A center of a region where the second antenna radiator 150 is located coincides with a center of an orthogonal projection of the multiple second parasitic radiators 160 on the plane where the second antenna radiator 150 is located.

As illustrated in the figure, for example, the second parasitic radiator 160 is implemented as four second parasitic radiators 160. A center of the second antenna radiator 150 is denoted as O2. A center of the multiple second parasitic radiators 160 refers to a center of the multiple second parasitic radiators 160 as a whole. For ease of description, the center of the multiple second parasitic radiators 160 as a whole is denoted as O2′. Center O2 coincides with Center O2′. The center of the region where the second antenna radiator 150 is located coincides with the center of the orthographic projection of the multiple second parasitic radiators 160 on the plane where the second antenna radiator 150 is located, which can improve the coupling effect between the second parasitic radiator 160 and the second antenna radiator 150, increase a strength of the RF signal in the fourth preset frequency band generated by a coupling between the second parasitic radiator 160 and the second antenna radiator 150, and improve the communication quality of the antenna module 10.

The second parasitic radiator 160 is a rectangular conductive patch and has a first side 161 facing the second antenna radiator 150 and a second side 162 connected with the first side 161. In another implementation, the second parasitic radiator 160 is a rectangular conductive patch and may have a first side 161 and a second side 162 connected with the first side 161, where the first side 161 is closer to the second antenna radiator 150 than the second side 162. A length of the first side 161 is larger than a length of the second side 162. The first side 161 is used to adjust a resonant frequency of the second parasitic radiator 160. The second side 162 is used to adjust an impedance between the second parasitic radiator 160 and the second antenna radiator 150.

Specifically, the resonant frequency of the second parasitic radiator 160 varies with the length of the first side 161. An impedance matching degree between the second parasitic radiator 160 and the second antenna radiator 150 varies with the length of the second side 162. Generally, the impedance matching degree between the second parasitic radiator 160 and the second antenna radiator 150 follows a normal distribution with the length of the second side 162. In other words, for radiating the same RF signal in the fourth preset frequency band, the impedance matching degree between the second parasitic radiator 160 and the second antenna radiator 150 is maximum when the length of the second side 162 is equal to a preset length a, and the impedance matching degree between the second parasitic radiator 160 and the second antenna radiator 150 decreases when the length of the second side 162 is smaller than or larger than the preset length.

In addition, when the second parasitic radiator 160 is stacked with and spaced apart from the second antenna radiator 150, the distance between the second parasitic radiator 160 and the second antenna radiator 150 also affects the coupling degree between the second parasitic radiator 160 and the second antenna radiator 150. The coupling degree between the second parasitic radiator 160 and the second antenna radiator 150 decreased as the distance between the second parasitic radiator 160 and the second antenna radiator 150 increases. Conversely, the coupling degree between the second parasitic radiator 160 and the second antenna radiator 150 increases as the distance between the second parasitic radiator 160 and the second antenna radiator 150 decreases. As the coupling degree between the second parasitic radiator 160 and the first antenna radiator 130 increases, the strength of the RF signal in the fourth preset frequency band generated by the second parasitic radiator 160 is increased accordingly, and the communication performance of the antenna module 10 is also improved.

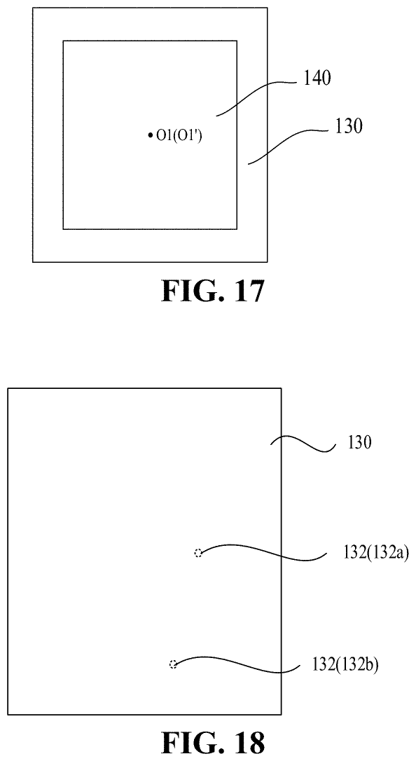

It should be understood, illustrations can be made to FIG. 17, which is a top view of a first antenna radiator and a first parasitic radiator in an antenna module provided in an implementation of the present disclosure. A center of a region where the first antenna radiator 130 is located coincides with a center of an orthographic projection of the first parasitic radiator 140 on a plane where the first antenna radiator 130 is located. For ease of description, the center of the region where the first antenna radiator 130 is located is denoted as O1, and the center of the orthographic projection of the first parasitic radiator 140 on the plane where the first antenna radiator 130 is located is denoted as O1′. Center O1′ coincides with Center O1. In this implementation, such structure of the first antenna radiator 130 and the first parasitic radiator 140 can improve the coupling effect between the first parasitic radiator 140 and the first antenna radiator 130, increase the strength of the RF signal in the second preset frequency band generated by the coupling of the first parasitic radiator 140 and the first antenna radiator 130, and further improve the communication quality of the antenna module 10.

In addition, a distance between the first parasitic radiator 140 and the first antenna radiator 130 also affects a coupling degree between the first parasitic radiator 140 and the first antenna radiator 130. The coupling degree between the first parasitic radiator 140 and the first antenna radiator 130 decreased as the distance between the first parasitic radiator 140 and the first antenna radiator 130 increases. Conversely, the coupling degree between the first parasitic radiator 140 and the first antenna radiator 130 increases as the distance between the first parasitic radiator 140 and the first antenna radiator 130 decreases. As the coupling degree between the first parasitic radiator 140 and the first antenna radiator 130 increases, the strength of the RF signal in the second preset frequency band generated by the first parasitic radiator 140 is increased accordingly, and the communication performance of the antenna module 10 is also improved.

Illustrating in FIGS. 1-3 again, the first antenna radiator 130 and the second antenna radiator 150 are conductive patches. The second antenna radiator 150 is closer to the RF chip 110 than the first antenna radiator 130. A frequency of the RF signal in the second frequency band range is lower than a frequency of the RF signal in the first frequency band range.

For an antenna radiator in a form of a conductive patch, the higher a frequency of an RF signal radiated by the conductive patch, the small a size of the conductive patch. Therefore, in this implementation, if the frequency of the RF signal in the second frequency band range is lower than the frequency of the RF signal in the first frequency band range, the size of the first antenna radiator 130 is smaller than that of the second antenna radiator 150. The second antenna radiator 150 is disposed closer to the RF chip 110 than the first antenna radiator 130, such that a relative low radiation intensity of or even shielding the RF signal in the third preset frequency band generated by the second antenna radiator 150 due to being blocked by the first antenna radiator 130 can be avoided. Therefore, in this implementation, the arrangement of the first antenna radiator 130 and the second antenna radiator 150 can improve the communication effect of the antenna module 10.

FIG. 4 shows, in some implementations, the antenna module 10 further includes a feeder. The second antenna radiator 150 defines a through hole 152 therein. The feeder extends through the through hole 152 and electrically connects the RF chip 110 with the first antenna radiator 130.

For ease of description, the feeder electrically connecting the RF chip 110 with the first antenna radiator 130 is named as the first feeder 170. That is, the RF chip 110 is electrically connected with the first antenna radiator 130 via the first feeder 170 embedded in the substrate 120. In this implementation, the first antenna radiator 130 is farther away from the RF chip 110 than the second antenna radiator 150, and the first antenna radiator 130 is stacked with and spaced apart from the second antenna radiator 150. In this way, the second antenna radiator 150 defines the through hole 152 therein, and the first feeder 170 can extend through via the through hole 152. In addition, for radiating the RF signal in the third preset frequency band, compared with the second antenna radiator 150 without the through hole 152, a surface current distribution of the second antenna radiator 150 can be changed by defining the through hole 152 in the second antenna radiator 150, which in turn allows the second antenna radiator 150 with the through hole 152 to have a smaller size than the second antenna radiator 150 without the through hole 152, facilitating the miniaturization of the antenna module 10.

In some implementations, the antenna module 10 further includes a second feeder 180. The RF chip 110 is electrically connected with the second antenna radiator 150 via the second feeder 180 embedded in the substrate 120. The first feeder 170 may be, but is not limited to, a feeding wire or a feeding probe. Accordingly, the second feeder 180 may be, but is not limited to, a feeding wire or a feeding probe.

In some implementations, the first antenna radiator 130 is farther away from the RF chip 110 than the second antenna radiator 150. The second parasitic radiator 160 is disposed at a side of the second antenna radiator 150 away from the first antenna radiator 130. The first parasitic radiator 140 is disposed at a side of the second parasitic radiator 160 away from the first antenna radiator 130. It can be understood that, in other implementations, the second parasitic radiator 160 may also be disposed at the same layer as the second antenna radiator 150. Alternatively, the second antenna radiator 150 may be disposed on any layer away from the RF chip 110. For example, the second parasitic radiator 160 is disposed at the same layer as the first antenna radiator 130, or the second parasitic radiator 160 is disposed at the same layer as the first parasitic radiator 140, as long as the second parasitic radiator 160 and the second antenna radiator 150 generate the RF signal in the fourth preset frequency band.

Illustrations can be made to FIG. 4 and FIG. 18, FIG. 18 is a top view of a first antenna radiator provided in an implementation of the present disclosure. The first antenna radiator 130 includes at least two first feeding points 132, each first feeding point 132 is electrically connected with the RF chip 110 via the first feeder 170. A distance between each first feeding point 132 and a center of the first antenna radiator 130 is larger than a first preset distance, which makes an output impedance of the RF chip 110 match an input impedance of the first antenna radiator 130. The input impedance of the first antenna radiator 130 can be changed by adjusting positions of the first feeding points 132, such that a matching degree between the input impedance of the first antenna radiator 130 and the output impedance of the RF signal can be changed, which makes more first excitation signals generated by the RF signal converted into the RF signals in the first preset frequency band for output, and reduces the amount of the first excitation signals not participating in conversion into the RF signal in the first preset frequency band, thereby improving an efficiency of conversing the first excitation signal into the RF signal in the first preset frequency band. It can be understood that only two first feeding points 132 are illustrated in FIG. 18, positions of the two first feeding points 132 here are merely illustrative, rather than limiting the first feeding points 132 in positions. In other implementations, the first feeding points 132 may also be arranged at other positions.

In case that the first antenna radiator 130 includes at least two first feeding points 132, the positions of the two first feeding points 132 are different, such that dual polarization of the RF signal in the first preset frequency band radiated by the first antenna radiator 130 can be realized. Specifically, for example, the first antenna radiator 130 includes the two first feeding points 132, and the two first feeding points 132 are respectively denoted as a first feeding point 132a and a first feeding point 132b. When the first excitation signal is loaded on the first antenna radiator 130 through the first feeding point 132a, the first antenna radiator 130 generates an RF signal in the first preset frequency band, and a polarization direction of the RF signal in the first preset frequency band is a first polarization direction. When the first excitation signal is loaded on the first antenna radiator 130 through the first feeding point 132b, the first antenna radiator 130 generates an RF signal in the first preset frequency band, and a polarization direction of the RF signal in the first preset frequency band is a second polarization direction, where the second polarization direction is different from the first polarization direction. It can be seen that the first antenna radiator 130 in this implementation can realize the dual polarization. When the first antenna radiator 130 can realize the dual polarization, the communication effect of the antenna module 10 can be improved. Compared with realizing different polarization through with two antennas in the traditional art, the number of antennas in the antenna module 10 can be reduced in this implementation.

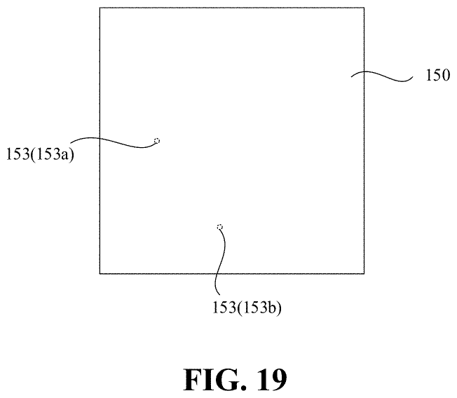

Illustrations can be made to FIG. 19, FIG. 19 is a top view of a second antenna radiator provided in an implementation of the present disclosure. The second antenna radiator 150 includes at least two second feeding points 153, each second feeding point 153 is electrically connected with the RF chip 110 via the second feeder 180. A distance between each second feeding point 153 and a center of the second antenna radiator 150 is larger than a second preset distance, which makes the output impedance of the RF chip 110 match an input impedance of the second antenna radiator 150. The input impedance of the second antenna radiator 150 can be changed by adjusting positions of the second feeding points 153, such that a matching degree between the input impedance of the second antenna radiator 150 and the output impedance of the RF signal can be changed, which makes more second excitation signals generated by the RF signal converted into the RF signals in the third preset frequency band for output, and reduces the amount of the second excitation signals not participating in conversion into the RF signal in the third preset frequency band, thereby improving an efficiency of conversing the second excitation signal into the RF signal in the third preset frequency band. It can be understood that only two second feeding points 153 are illustrated in FIG. 19, positions of the two second feeding points 153 here are merely illustrative, rather than limiting the second feeding points 153 in positions. In other implementations, the second feeding points 153 may also be arranged at other positions.

In case that the second antenna radiator 150 includes at least two second feeding points 153, the positions of the two second feeding points 153 are different, such that dual polarization of the RF signal in the third preset frequency band radiated by the second antenna radiator 150 can be realized. Specifically, for example, the second antenna radiator 150 includes the two second feeding points 153, and the two second feeding points 153 are respectively denoted as a second feeding point 153a and a second feeding point 153b. When the second excitation signal is loaded on the second antenna radiator 150 through the second feeding point 153a, the second antenna radiator 150 generates an RF signal in the third preset frequency band, and a polarization direction of the RF signal in the third preset frequency band is a third polarization direction. When the second excitation signal is loaded on the second antenna radiator 150 through the second feeding point 153a, the second antenna radiator 150 generates an RF signal in the fourth preset frequency band, and a polarization direction of the RF signal in the fourth preset frequency band is a fourth polarization direction, where the third polarization direction is different from the fourth polarization direction. It can be seen that the second antenna radiator 150 in this implementation can realize the dual polarization. When the second antenna radiator 150 can realize the dual polarization, the communication effect of the antenna module 10 can be improved. Compared with realizing different polarization through with two antennas in the traditional art, the number of antennas in the antenna module 10 can be reduced in this implementation.

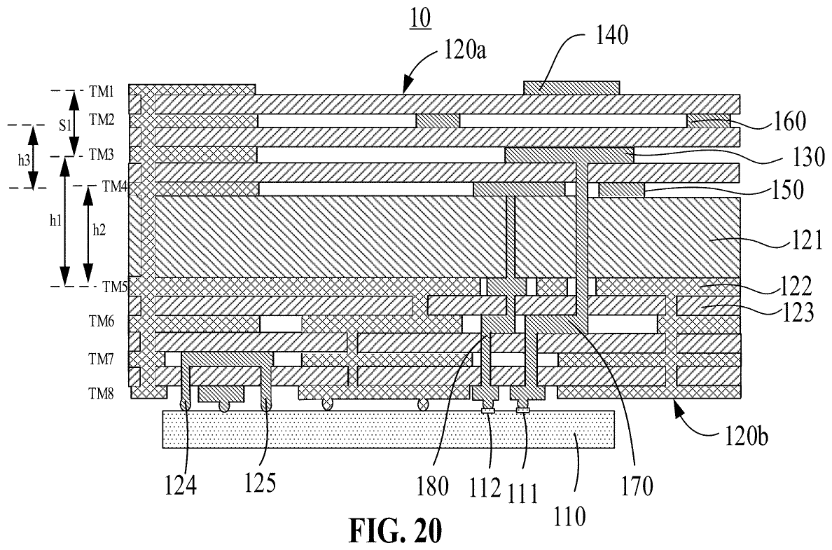

Illustrations can be made to FIG. 20, which is a cross-sectional view of an antenna module provided in an implementation of the present disclosure. In this implementation, for example, the antenna module 10 adopts a multi-layer structure formed by a high density interconnection (HDI) process or an integrated circuit (IC) carrier board process. In this implementation, the substrate 120 has a first surface 120a and a second surface 120b opposite to the first surface 120a. The first parasitic radiator 140 is disposed on the first surface 120a of the substrate 120. The RF chip 110 is disposed on the second surface 120b of the substrate 120. The first antenna radiator 130, the second antenna radiator 150, and the second parasitic radiator 160 are embedded in the substrate 120. In this implementation, the first antenna radiator 130 is embedded in the substrate 120 and stacked with and spaced apart from the first parasitic radiator 140. The second parasitic radiator 160 is disposed between the first parasitic radiator 140 and the first antenna radiator 130. The second antenna radiator 150 is disposed at a side of the first antenna radiator 130 away from the second parasitic radiator 160. It is understood that in other implementations, the first parasitic radiator 140, the first antenna radiator 130, the second parasitic radiator 160, and the second antenna radiator 150 may be in other positional relationships, as long as the first parasitic radiator 140 can be coupled with the first antenna radiator 130 and the second parasitic radiator 160 can be coupled with the second antenna radiator 150.

The substrate 120 includes a core layer 121 and multiple wiring layers 122 stacked on two opposite sides of the core layer 121. The core layer 121 is an insulating layer. Generally, an insulating layer 123 is disposed between each two wiring layers 122. The core layer 121 and the insulating layers 123 can be made of a high-frequency low-loss mmWave material. For example, for the high-frequency low-loss mmWave material, dielectric constant Dk=3.4 and loss factor Df=0.004. The thickness of the core layer 121 may be, but is not limited to, 0.45 mm. The thickness of all insulating layers 123 in the substrate 120 may be, but is not limited to, 0.35 mm. The thicknesses of each insulating layer 123 in the substrate 120 may be equal or unequal.

In this implementation, for example, the substrate 120 has an 8-layer structure, it can be understood that in other implementations, the substrate 120 may also have other numbers of layers. The substrate 120 includes a core layer 121, a first wiring layer TM1, a second wiring layer TM2, a third wiring layer TM3, a fourth wiring layer TM4, a fifth wiring layer TM5, a sixth wiring layer TM6, a seventh wiring layer TM7, and an eighth wiring layer TM8. The first wiring layer TM1, the second wiring layer TM2, the third wiring layer TM3, and the fourth wiring layer TM4 are stacked on the same side of the core layer 121 in sequence. In an implementation, the first wiring layer TM1, the second wiring layer TM2, the third wiring layer TM3, and the fourth wiring layer TM4 are sequentially stacked on the same side of the core layer 121 and spaced apart from one another. The first wiring layer TM1 is farther away from the core layer 121 than the fourth wiring layer TM4. A surface of the first wiring layer TM1 away from the core layer 121 acts as least a part of a first surface 120a of the substrate 120. In an implementation, the surface of the first wiring layer TM1 away from the core layer 121 is flush with the first surface 120a of the substrate 120. In an implementation, the first wiring layer TM1 is on the first surface 120a of the substrate 120. The fifth wiring layer TM5, the sixth wiring layer TM6, the seventh wiring layer TM7, and the eighth wiring layer TM8 are stacked on the same side of the core layer 121 in sequence. In an implementation, the fifth wiring layer TM5, the sixth wiring layer TM6, the seventh wiring layer TM7, and the eighth wiring layer TM8 are sequentially stacked on the same side of the core layer 121 and spaced apart from one another. The eighth wiring layer TM8 is disposed farther away from the core layer 121 than the fifth wiring layer TM5. A surface of the eighth wiring layer TM8 away from the core layer 121 acts as least a part of a second surface 120b of the substrate 120. In an implementation, the surface of the eighth wiring layer TM8 away from the core layer 121 is flush with the second surface 120b of the substrate 120. In an implementation, the eighth wiring layer TM8 is on the second surface 120b of the substrate 120. The fifth wiring layer TM5 and the fourth wiring layer TM4 are disposed at two opposite sides of the core layer 121. Generally, the first wiring layer TM1, the second wiring layer TM2, the third wiring layer TM3, and the fourth wiring layer TM4 are wiring layers where antenna radiators can be disposed. The fifth wiring layer TM5 is a ground layer where a ground electrode is disposed. The sixth wiring layer TM6, the seventh wiring layer TM7, and the eighth wiring layer TM8 are wiring layers where a feeding network and control lines in the antenna module 10 are disposed.

In the schematic view of implementations, for example, the first parasitic radiator 140 is disposed in the first wiring layer TM1, the second parasitic radiator 160 is disposed in the second wiring layer TM2, the first antenna radiator 130 is disposed in the third wiring layer TM3, and the second antenna radiator 150 is disposed in the fourth wiring layer TM4.

Furthermore, the first wiring layer TM1, the second wiring layer TM2, the third wiring layer TM3, the fourth wiring layer TM4, the sixth wiring layer TM6, the seventh wiring layer TM7, and the eighth wiring layer TM8 in the substrate 120 are electrically connected with the ground layer in the fifth wiring layer TM5. Specifically, each of the first wiring layer TM1, the second wiring layer TM2, the third wiring layer TM3, the fourth wiring layer TM4, the sixth wiring layer TM6, the seventh wiring layer TM7, and the eighth wiring layer TM8 in the substrate 120 defines a through hole, conductive materials are disposed in the through hole to electrically connect with the ground layer in the fifth wiring layer TM5, such that devices disposed in various wiring layers 122 are grounded. The devices disposed in various wiring layers 122 may be devices required for operation of the antenna module 10, for example, a device for received-signal processing, a device for emission signal processing, etc.

Moreover, a power supply line 124 and a control line 125 are further disposed in the seventh wiring layer TM7 and the eighth wiring layer TM8. The power supply line 124 and the control line 125 are electrically connected with the RF chip 110 respectively. The power supply line 124 is configured to supply the RF chip 110 with power needed by the RF chip 110, and the control line 125 is configured to transmit a control signal to the RF chip 110 to control operation of the RF chip 110.

The RF chip 110 is provided with a first output end 111 and a second output end 112 at a surface of the RF chip 110 facing the core layer 121. The first antenna radiator 130 includes at least one first feeding point 132 (illustrations can be made to FIG. 18). The RF chip 110 is configured to generate the first excitation signal, and the first output end 111 is configured to be electrically connected with the first feeding point 132 of the first antenna radiator 130 through the first feeder 170, to output the first excitation signal to the first antenna radiator 130. The first antenna radiator 130 is configured to generate the RF signal in the first preset frequency band according to the first excitation signal. Correspondingly, illustrating in FIG. 19, the second antenna radiator 150 includes at least one second feeding point 153. The RF chip 110 is further configured to generate the second excitation signal, and the second output end 112 is configured to be electrically connected with the second feeding point 153 of the second antenna radiator 150 through the second feeder 180, to output the second excitation signal to the second antenna radiator 150. The second antenna radiator 150 is configured to generate the RF signal in the third preset frequency band according to the second excitation signal. The first output end 111 and the second output end 112 face the core layer 121, such that the length of the first feeder 170 electrically connected with the first antenna radiator 130 is relatively short, thereby reducing a loss of transmitting the first excitation signal by the first feeder 170, which makes a generated RF signal in the first frequency band have a better radiation gain. Likewise, the length of the second feeder 180 electrically connected with the second antenna radiator 150 is relatively short, thereby reducing a loss of transmitting the second excitation signal by the second feeder 180, which makes a generated RF signal in the third preset frequency band have a better radiation gain. The first output end 111 and the second output end 112 may also be connected with the substrate 120 by a welding process. The first output end 111 and the second output end 112 described above are connected with the substrate 120 by the welding process, and the first output end 111 and the second output end 112 face the core layer 121, therefore, this process is named a flip-chip process, and that the RF chip 110 is electrically connected with the first antenna radiator 130 and the second antenna radiator 150 respectively by a substrate process or the HDI process, so as to realize that the RF chip 110 is interconnected with the first antenna radiator 130 and the second antenna radiator 150 respectively. The first antenna radiator 130, the first parasitic radiator 140, the second antenna radiator 150, and the second parasitic radiator 160 may adopt forms of conductive patches (also called patch antennas) or dipole antennas. The first feeder 170 may be a feeding conductive wire or a feeding probe. The second feeder 180 may be a feeding conductive wire or a feeding probe.

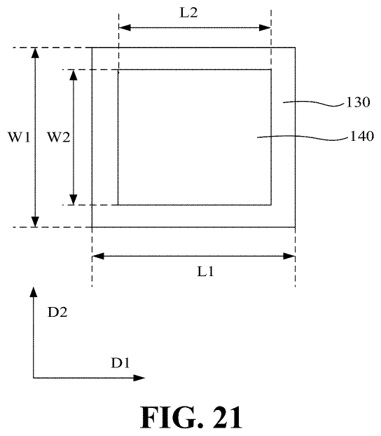

Illustrations can be made to FIG. 21, which is a schematic diagram illustrating a size of a first antenna radiator and a size of a first parasitic radiator provided in implementations of the present disclosure. The size of the first antenna radiator 130 and the size of the first parasitic radiator 140 are described below with illustrations to FIG. 21.

The size of the first antenna radiator 130, the size of the second antenna radiator 150, and the distance between the first parasitic radiator 140 and the first antenna radiator 130 are not arbitrarily determined, but are obtained through strict design and adjustment in consideration of a frequency band of the RF signal in the first preset frequency band radiated by the first antenna radiator 130, a frequency band of the RF signal in the second preset frequency band radiated by the first parasitic radiator 140, and a bandwidth of the first frequency band range. Design and adjustment processes are described as follows.

The first antenna radiator 130 and the first parasitic radiator 140 of the antenna module 10 are usually carried by the substrate 120. A relative dielectric constant εᵣ of the substrate 120 is usually 3.4. A distance between the first antenna radiator 130 and a ground layer in the substrate 120 is 0.4 mm. Thus, width w of the first antenna radiator 130 can be calculated by formula (1):

$$w = \frac{c}{2 f \sqrt{\frac{( {ε}_{r} + 1 )}{2}}} \qquad ( 1 )$$

where c represents the light speed, f represents a resonant frequency of the first antenna radiator 130, εᵣ is a relative dielectric constant of a medium between the first antenna radiator 130 and the ground layer in the antenna module 10. For example, in the foregoing antenna module 10, the medium between the first antenna radiator 130 and the ground layer in the antenna module 10 is the core layer 121 and each insulating layer 123 which are between the first antenna radiator 130 and the ground layer.

A length of the first antenna radiator 130 is generally taken as

$$\frac{λ}{2} ,$$

but due to the edge effect, an actual size L of the first antenna radiator 130 is usually larger than

$$\frac{λ}{2} .$$

The actual length L of the first antenna radiator 130 can be calculated by formula (2) and formula (3):

$$L = \frac{c}{2 f \sqrt{{ε}_{e}}} - 2 Δ L \qquad ( 2 )$$

$$λ = \frac{{λ}_{0}}{\sqrt{{ε}_{r}}} \qquad ( 3 )$$

where λ represents a wavelength of a guided wave in the medium, λ₀ represents a wavelength in free space, εₑ represents an effective dielectric constant, and ΔL represents a width of an equivalent radiation gap.

The effective dielectric constant εₑ can be calculated by formula (4):

$${ε}_{e} = \frac{{ε}_{r + 1}}{2} + \frac{{ε}_{r - 1}}{2} {( 1 + 12 \frac{h}{w} )}^{- \frac{1}{2}} \qquad ( 4 )$$

where h represents the distance between the first antenna radiator 130 and the ground layer.

The width ΔL of the equivalent radiation gap can be calculated by formula (5):

$$Δ L = 0.412 \frac{( {ε}_{r} + 0.3 ) ( \frac{W}{h} + 0 \text{.264} )}{( {ε}_{r} - 0.258 ) ( \frac{W}{h} + 0.8 )} h \qquad ( 5 )$$

The resonant frequency of the first antenna radiator 130 can be calculated by formula (6):

$$f = \frac{1}{2 ( L + 2 Δ L ) \sqrt{{μ}_{0} {ε}_{0}} \sqrt{{ε}_{r}}} \qquad ( 6 )$$

For example, the resonant frequency of the first antenna radiator 130 is 39 GHz, the length and the width of the first antenna radiator 130 are calculated according to formulas (1)-(6). The distance between the first antenna radiator 130 and the first parasitic radiator 140, the distance between the first antenna radiator 130 and the ground layer, and the length and the width of the first parasitic radiator 140 are preset, modeling and analyzing are performed according to the above parameters, a radiation boundary and a radiation port of the antenna module 10 are set, and a variation curve of return loss with frequency can be obtained by frequency sweep.

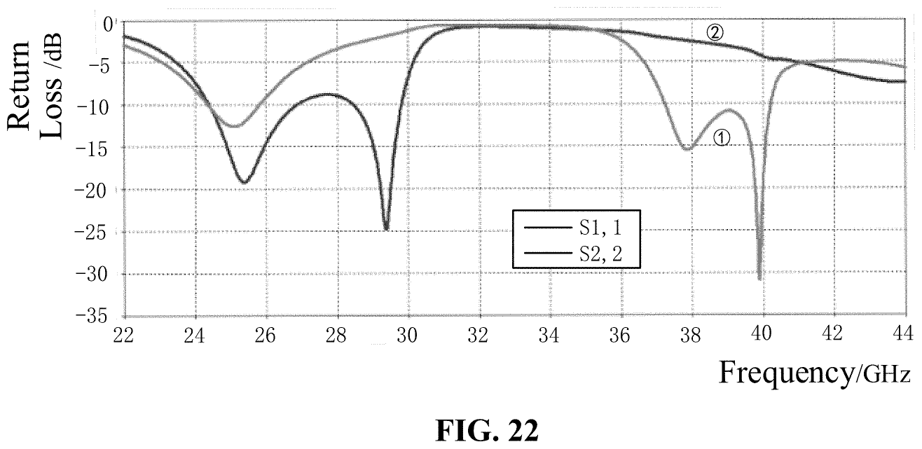

The bandwidth of the RF signal in the first preset frequency band radiated by the first antenna radiator 130 is further optimized according to the obtained variation curve of return loss with frequency. A length L1 and a width W1 of the first antenna radiator 130, a distance S1 between the first antenna radiator 130 and the first parasitic radiator 140 (illustrating in FIG. 20), a distance h1 between the first antenna radiator 130 and the ground layer (illustrating in FIG. 20), and a length L2 of the first parasitic radiator 140 are further adjusted, to optimize the variation curve of return loss with frequency. Illustrations can be made to FIG. 22, which illustrates variation curves of return loss with frequency of an optimized antenna module provided in an implementation of the present disclosure, and the RF signal in the first frequency band range with a bandwidth of 37˜40.5 GHz is further obtained (see curve \textcircled{1}). In other words, the RF signal in the first frequency band range includes frequency band n260.

A range of the length L1 and a range of the width W1 of the first antenna radiator 130, a range of the distance S1 between the first antenna radiator 130 and the first parasitic radiator 140, a range of the distance h1 between the first antenna radiator 130 and the ground layer, and a range of the length L2 of the first parasitic radiator 140 can be obtained based on an adjustment process of the length L1 and the width W1 of the first antenna radiator 130, the distance S1 between the first antenna radiator 130 and the first parasitic radiator 140, the distance h1 between the first antenna radiator 130 and the ground layer, and the length L2 of the first parasitic radiator 140,

Illustration can be made to FIG. 21 again, the first antenna radiator 130 is a rectangular patch, a size of the first antenna radiator 130 in a first direction D1 and a size of the first antenna radiator 130 in a second direction D2 are smaller than or equal to 2 mm. The size of the first antenna radiator 130 in the first direction D1 is the length of the first antenna radiator 130, and the size of the first antenna radiator 130 in the second direction D2 is the width W1 of the first antenna radiator 130. In other words, the length L1 of the first antenna radiator 130 ranges from 0 to 2.0 mm, and the width W1 of the first antenna radiator 130 ranges from 0 to 2.0 mm. Further, the length L1 of the first antenna radiator 130 ranges from 1.6 mm to 2.0 mm, and the width W1 of the first antenna radiator 130 ranges from 1.6 mm to 2.0 mm, such that the bandwidth of the RF signal in the first frequency band range radiated by the first antenna radiator 130 and the first parasitic radiator 140 ranges from 37 GHz to 40.5 GHz. Generally, for the first antenna radiator 130 whose width is constant, the larger the length L1 of the first antenna radiator 130, the more the resonant frequency of the RF signal in the first preset frequency band shifts towards a low frequency. For the first antenna radiator 130 whose width is constant, the smaller the length L1 of the first antenna radiator 130, the more the resonant frequency of the RF signal in the first preset frequency band shifts towards a high frequency.

Illustrations can be made to FIG. 21, the length L2 of the first parasitic radiator 140 is smaller to the length L1 of the first antenna radiator 130. A width W2 of the second parasitic radiator 160 ranges from 0.2 mm to 0.9 mm. The distance S1 between the first antenna radiator 130 and the first parasitic radiator 140 ranges from 0.2 mm to 0.8 mm. The first antenna radiator 130 is configured to excite the RF signal in the first preset frequency band between the first antenna radiator 130 and the ground layer, and the RF signal in the first preset frequency band radiates outward though a gap defined between the first antenna radiator 130 and the ground layer. The first parasitic radiator 140 is coupled with the RF signal in the first preset frequency band radiated by the first antenna radiator 130 to generate the RF signal in the second preset frequency band. Effective coupling cannot be achieved when the distance between the first antenna radiator 130 and the first parasitic radiator 140 is excessively large or small. When the distance S1 between the first antenna radiator 130 and the first parasitic radiator 140 ranges from 0.2 mm to 0.8 mm, the coupling effect between the first antenna radiator 130 and the first parasitic radiator 140 is relatively good, and the RF signal in the first frequency band range has a relatively wide bandwidth.

Illustrations can be made to FIG. 20, and the distance h1 between the first antenna radiator 130 and the ground layer ranges from 0.7 mm to 0.9 mm. A distance h2 between the second antenna radiator 150 and the ground layer ranges from 0.3 mm to 0.6 mm.

Specifically, the distance h2 between the second antenna radiator 150 and the ground layer is equal to the thickness of the core layer 121 in the substrate 120. When the thickness of the core layer 121 in the substrate 120 is excessively small, it is easy to cause the antenna module 10 to warp during molding. When the thickness of the core layer 121 in the substrate 120 is excessively large, it is not beneficial to thinness of the antenna module 10. Therefore, considering comprehensively, the distance h2 between the second antenna radiator 150 and the core layer 121 is designed to range from 0.3 mm to 0.6 mm, which can meet requirements for both thinness and non-warping of the antenna module 10.

In order to obtain a desired bandwidth, the distance between the first antenna radiator 130 and the ground layer can be adjusted appropriately. Generally, the distance h1 between the first antenna radiator 130 and the ground layer is in direct proportion to a bandwidth. In other words, the larger the distance h1 between the first antenna radiator 130 and the ground layer, the wider the bandwidth of the RF signal in the first preset frequency band radiated by the first antenna radiator 130. Conversely, the smaller the distance h1 between the first antenna radiator 130 and the ground layer, the narrower the bandwidth of the RF signal in the first preset frequency band radiated by the first antenna radiator 130. Specifically, by increasing the distance between the first antenna radiator 130 and the ground layer, energy radiated by first antenna radiator 130 can be increased, that is, the bandwidth of the RF signal in the first preset frequency band radiated by the first antenna radiator 130 is widened. However, more surface waves will be excited due to an increase in the distance between the first antenna radiator 130 and the ground layer, which will decrease radiation in a desired direction of the RF signal in the first preset frequency band and change directivity characteristics of the radiation of the first antenna radiator 130. Therefore, taking the bandwidth and directivity of the RF signal in the first preset frequency band into consideration, the distance h1 between the first antenna radiator 130 and the ground layer is determined to range from 0.7 mm to 0.9 mm.

According to a relationship between the size of the first antenna radiator 130 and a frequency, a relationship between the size of the first parasitic radiator 140 and a frequency, and a relationship between the distance between the first antenna radiator 130 and the first parasitic radiator 140 and a frequency, the size of the first antenna radiator 130, the size of the first parasitic radiator 140, and the distance between the first antenna radiator 130 and the first parasitic radiator 140 are adjusted, so that the variation curve of return loss with frequency can be optimized. Illustrations can be made FIG. 22, which illustrates variation curves of return loss with frequency for an optimized antenna module provided in an implementation of the present disclosure, and the RF signal in the first frequency band range with a frequency band of 37 GHz˜40.5 GHz is then obtained. In FIG. 22, the horizontal axis represents the frequency in units of GHz, the vertical axis represents the return loss in units of decibel (dB). Curve \textcircled{1} represents the variation curve of return loss with frequency of the RF signal in the first frequency band range. Curve \textcircled{2} represents the variation curve of return loss with frequency of the RF signal in the second frequency band range. In FIG. 22, frequencies corresponding to ordinates which each is less than or equal to −10 dB belong to an operating band of the antenna module 10. It can be seen from curve \textcircled{1} that frequency bands of the RF signals in the first frequency band range are from 37 GHz to 40.5 GHz, that is, frequency band n260 (37 GHz-40 GHz) is achieved.

By adjusting the size of the first antenna radiator 130, the size of the first parasitic radiator 140, the distance between the first antenna radiator 130 and the first parasitic radiator 140, the first antenna radiator 130 can generate the first resonance in the first frequency band range, and the first parasitic radiator 140 can generate the second resonance in the second frequency band range. As can be seen from FIG. 22, resonant frequencies of the first resonance and the second resonance are 37.8 GHz and 39.9 GHz, respectively, that is, the first antenna radiator 130 and the first parasitic radiator 140 resonate at 37.8 GHz and 39.9 GHz, respectively. When the bandwidth of the RF signal in the first preset frequency band generated by the first antenna radiator 130 is constant and the bandwidth of the RF signal in the second preset frequency band generated by the first parasitic radiator 140 is constant, compared with a situation where the first resonance is the same as the second resonance, the first resonance being different from the second resonance can widen the bandwidth of the first frequency band range and improve the communication performance of the antenna module 10.

Similar to the first antenna radiator 130, a center frequency of the RF signal in the third preset frequency band radiated by the second antenna radiator 150 is 25 GHz and a center frequency of the RF signal in the fourth preset frequency band radiated by the second parasitic radiator 160 is 29 GHz. By designing the size of the second antenna radiator 150, the distance between the second antenna radiator 150 and the second parasitic radiator 160, the distance between the second antenna radiator 150 and the ground layer, the size of the second parasitic radiator 160, and the distance between the second parasitic radiator 160 and the ground layer, the bandwidth of the RF signal in the second frequency band range is broadened to obtain an RF signal with a frequency band of 24.5 GHz˜29.9 GHz (illustrating in Curve \textcircled{2} in FIG. 22), which basically realizes an RF signal coverage in frequency bands n257 (26.529.5 GHz), n258 (24.25˜27.5 GHz), and n261 (27.5˜28.35 GHz). Adjustion and control can be carried out in specific implementations as follows. Formulas (1)-(6) can be directly used for the second antenna radiator 150, and formulas (1)-(6) will not be repeated herein.

A relative dielectric constant εᵣ of the insulating layer 123 in the substrate 120 is determined to be 3.4. The distance between the second antenna radiator 150 and the ground layer is 0.5 mm. According to a resonant frequency of the second antenna radiator 150 to be designed which is 39 GHz and formulas (1)-(6), a length L3 and a width W3 of the second antenna radiator 150 can be calculated. A horizontal distance S2 and a vertical distance h3 between the second antenna radiator 150 and the second parasitic radiator 160, the distance h2 between the second antenna radiator 150 and the ground layer, and a length L4 and a width W4 of the second parasitic radiator 160 are preset. Modeling and analyzing are performed according to the above parameters, a radiation boundary, a boundary condition, and a radiation port are set, and a variation curve of a return loss with a frequency is obtained by frequency sweep.

According to the above variation curves of return loss with frequency, the bandwidth of the RF signal in the third preset frequency band radiated by the second antenna radiator 150 is further optimized. The length L3 and the width W3 of the second antenna radiator 150, the horizontal distance S2 and the vertical distance h3 between the second antenna radiator 150 and the second parasitic radiator 160, the distance h2 between the second antenna radiator 150 and the ground layer, and the length L4 of the second parasitic radiator 160 are further adjusted, to optimize the variation curve of return loss with frequency, and in turn obtain the RF signal in the second frequency band range with a bandwidth of 24.5˜29.9 GHz (illustrating in curve \textcircled{2} in FIG. 22).

A range of the length L3 and a range of the width of the second antenna radiator 150, a range of the horizontal distance and a range of the vertical distance between the second antenna radiator 150 and the second parasitic radiator 160, a range of the distance between the second antenna radiator 150 and the ground layer, and a range of the length of the second parasitic radiator 160 can be obtained, based on the above adjustment process of the length L3 and the width W3 of the second antenna radiator 150, the horizontal distance S2 and the vertical distance h3 between the second antenna radiator 150 and the second parasitic radiator 160, the distance h2 between the second antenna radiator 150 and the ground layer, and the length L4 of the second parasitic radiator 160, which is the same as the same as an adjustment method of the first antenna radiator 130.

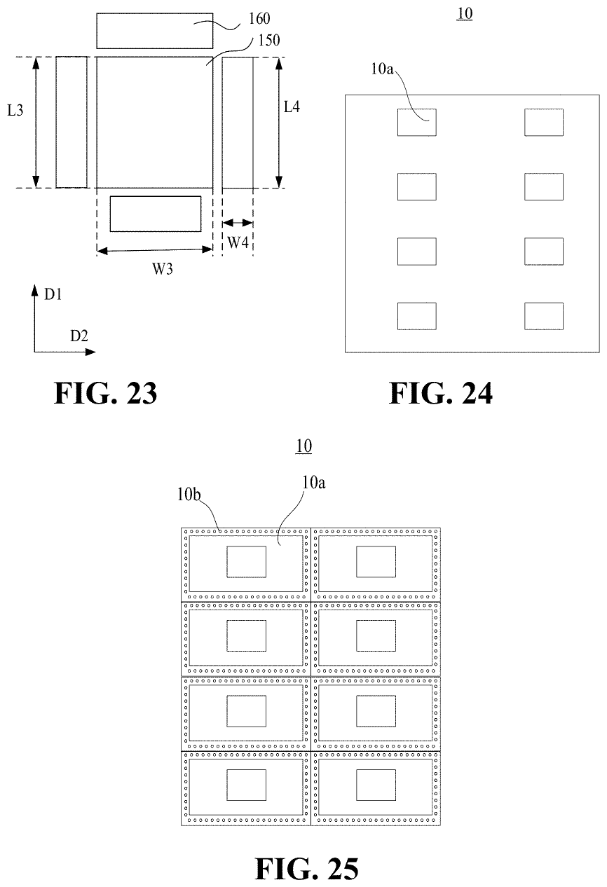

Illustrations can be made to FIG. 23, which is a top view of a second antenna radiator and a second parasitic radiator. In this implementation, only the second antenna radiator 150 and the second parasitic radiator 160 of the antenna module 10 are illustrated, while other components are omitted. The second antenna radiator 150 is a rectangular conductive patch, a size of the second antenna radiator 150 in the first direction D1 ranges from 2.0 mm to 2.8 mm. The size of the second antenna radiator 150 in the first direction D1 is the length of the second antenna radiator 150, which is denoted as L3. In other words, the length L3 of the second antenna radiator 150 ranges from 2.0 mm to 2.8 mm. A size of the second antenna radiator 150 in the second direction D2 also ranges from 2.0 mm to 2.8 mm. The size of the second antenna radiator 150 in the second direction D2 is the width of the second antenna radiator 150, which is denoted as W3. In other words, the width W3 of the second antenna radiator 150 ranges from 2.0 mm to 2.8 mm, such that the bandwidth of the RF signal in the second frequency band range radiated by the second antenna radiator 150 and the second parasitic radiator 160 ranges from 24.5 GHz to 29.9 GHz. Generally, the larger the length L3 of the second antenna radiator 150, the more the resonant frequency of the second RF signal shifts towards a low frequency.

Furthermore, illustrations can be made to FIG. 23, the second parasitic radiator 160 is a rectangular conductive patch, the second parasitic radiator 160 is a rectangular conductive patch. The length L3 of the second antenna radiator 150 is equal to the length L4 of the second parasitic radiator 160. The length of a short edge of the second parasitic radiator 160 ranges from 0.2 to 0.9 mm, in other words, the width W4 of the second parasitic radiator 160 ranges from 0.2 to 0.9 mm. When the second parasitic radiator 160 is stacked with and spaced apart from the second antenna radiator 150, the distance h3 (illustrations can be made to FIG. 20) from the second parasitic radiator 160 to the second antenna radiator 150 ranges from 0 to 0.6 mm.

A gap between a projection of the second parasitic radiator 160 on a plane perpendicular to a plane where the second antenna radiator 150 is located and a region where the second antenna radiator 150 is located ranges from 0.2 mm to 0.8 mm. In another implementation, a gap between an orthographic projection of the second parasitic radiator 160 on the plane where the second antenna radiator 150 is located and the region where the second antenna radiator 150 is located ranges from 0.2 mm to 0.8 mm.

Such structure of the second antenna radiator 150 and the second parasitic radiator 160 can make the second antenna radiator 150 and the second parasitic radiator 160 have different resonances, so that the antenna module 10 has a wider bandwidth in the second frequency band range. Specifically, illustrating in curve \textcircled{2} in FIG. 22, a third resonance is 25 GHz and a fourth resonance is 29 GHz.

By adjusting the size of the second antenna radiator 150, the size of the second parasitic radiator 160, the distance between the second antenna radiator 150 and the second parasitic radiator 160, the second antenna radiator 150 can resonate at the third resonance, the second parasitic radiator 160 can resonate at the fourth resonance, and the third resonance is different from the fourth resonance. As can be seen from FIG. 22, the third resonance is 25 GHz and the fourth resonance is 29 GHz, that is, the second antenna radiator 150 is 25 GHz and the second parasitic radiator 160 is 29 GHz. When the bandwidth of the RF signal in the third preset frequency band generated by the second antenna radiator 150 is constant and the bandwidth of the RF signal in the fourth preset frequency band generated by the second parasitic radiator 160 is constant, compared with a situation where the third resonance is the same as the fourth resonance, the third resonance being different from the fourth resonance can widen the bandwidth of the second frequency band range and improve the communication performance of the antenna module 10.

Illustrations can be made to FIG. 24, which is a schematic view of an antenna module provided in an implementation of the present disclosure. The antenna module 10 includes multiple antenna units 10a arranged in an array, for example, the multiple antenna units 10a are arranged in an M×N array to form a phased array antenna. Each antenna unit 10a includes the first antenna radiator 130, the first parasitic radiator 140, the second antenna radiator 150, and the second parasitic radiator 160. As for the first antenna radiator 130, the first parasitic radiator 140, the second antenna radiator 150, and the second parasitic radiator 160, illustrations can be made to the foregoing descriptions, which will not be repeated herein. Based on the size design of the first antenna radiator 130, the first parasitic radiator 140, the second antenna radiator 150, the second parasitic radiator 160 described above, the width of the antenna unit 10a can be less than 4.2 mm and the length of the antenna unit 10a can be less than 5 mm, which realizes miniaturization of the antenna unit 10a, and in turn realizes the miniaturization of the antenna module 10. When the antenna module 10 is applied to an electronic device 1, it is beneficial to thinness design of the electronic device 1.

Illustrations can be made to FIG. 25, which is a schematic view of an antenna module provided in another implementation of the present disclosure. The antenna module 10 includes multiple antenna units 10a arranged in an array. Each antenna unit 10a includes the first antenna radiator 130, the first parasitic radiator 140, the second antenna radiator 150, and the second parasitic radiator 160. As for the first antenna radiator 130, the first parasitic radiator 140, the second antenna radiator 150, and the second parasitic radiator 160, illustrations can be made to the previous descriptions, which will not be repeated herein. In this implementation, multiple metallization-via-hole grids 10b are defined between adjacent antenna units 10a. The metallization-via-hole grid 10b is used to isolate interference between adjacent antenna units 10a, so as to improve the radiation effect of the antenna module 10.

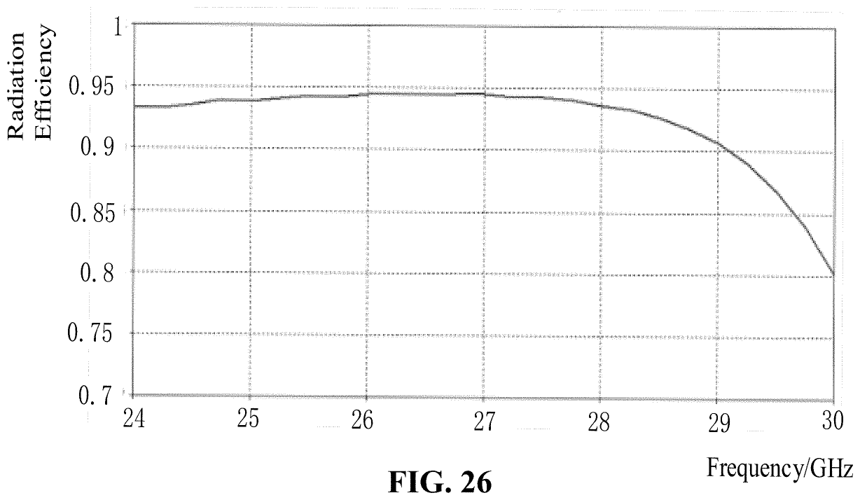

Simulations of the antenna module 10 provided in the present disclosure are given below. Illustrations can be made to FIG. 26, which is a schematic view illustrating radiation efficiency of an RF signal of 24˜30 GHz radiated by an antenna module of the present disclosure. In FIG. 26, the horizontal axis represents a frequency in units of GHz, and the vertical axis represents radiation efficiency without units. In FIG. 26, a curve illustrates the radiation efficiency of the RF signal of 24˜30 GHz. The radiation efficiency of the RF signal is relatively high at 24˜30 GHz, and is higher than 0.80. The RF signal of 24˜30 GHz covers frequency bands n257, n258, and n261. That is, the antenna module 10 of the present disclosure has a higher radiation efficiency when the second frequency band range is frequency bands n257, n258, and n261.

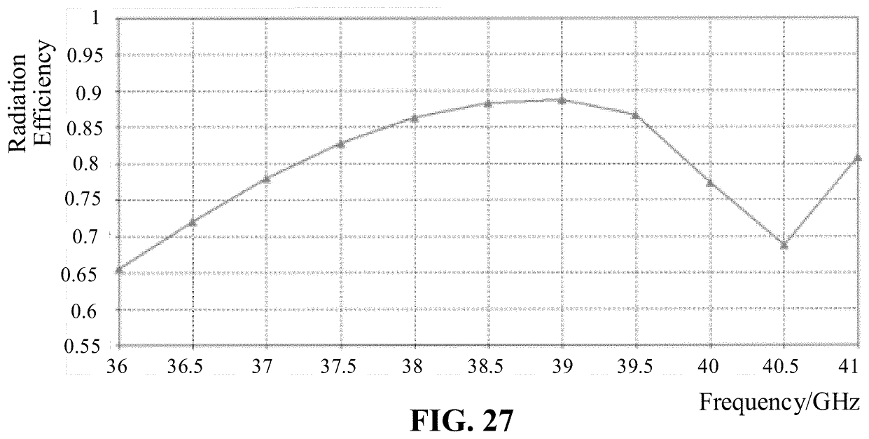

Illustrations can be made to FIG. 27, which is a schematic diagram illustrating radiation efficiency of an RF signal of 36˜41 GHz radiated by an antenna module of the present disclosure. In FIG. 27, the horizontal axis represents a frequency in units of GHz, and the vertical axis represents radiation efficiency without units. In FIG. 27, a curve illustrates the radiation efficiency of the RF signal of 36˜41 GHz. It can be seen from the curve that the radiation efficiency of the RF signal is relatively high at 36˜41 GHz, and is higher than 0.65. When the first frequency band range is n260 (37˜40 GHz), the radiation efficiency is also relatively high.

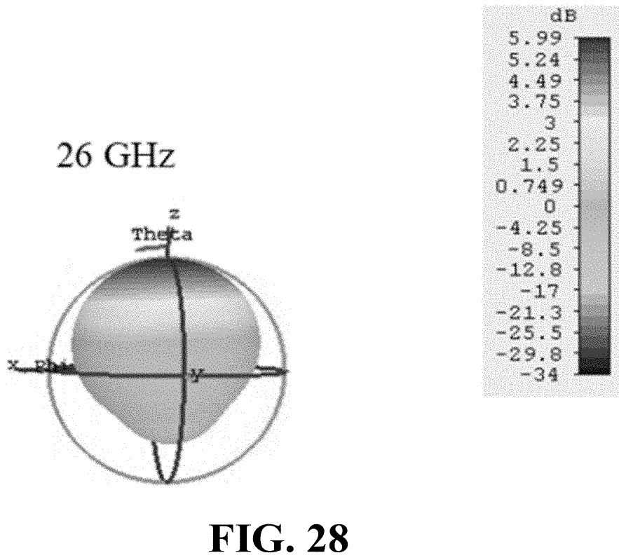

Illustrations can be made to FIG. 28, which is a directional simulation pattern of an antenna module at 26 GHz of the present disclosure. At 26 GHz, the maximum value of a gain is 5.99 dB, which indicates that there is a better directivity at 26 GHz, and the antenna module 10 has better communication effect at 26 GHz.

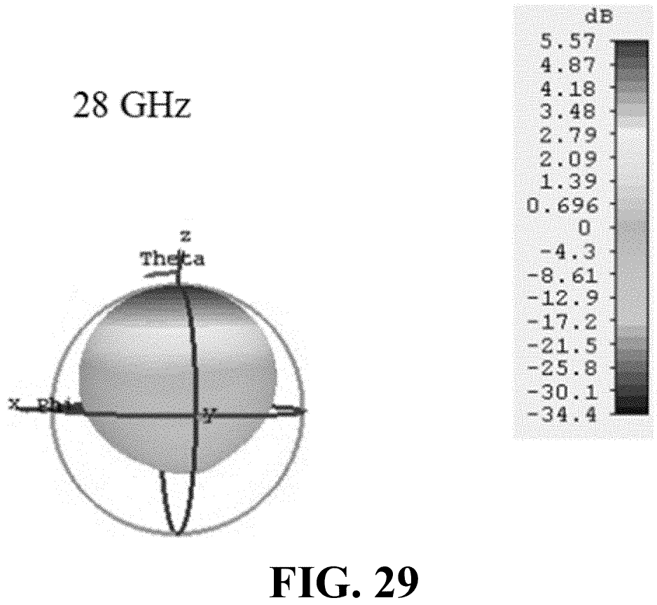

Illustrations can be made to FIG. 29, which is a directional simulation pattern of an antenna module at 28 GHz of the present disclosure. In this directional simulation pattern, the maximum value of a gain is 5.57 dB, which indicates that there is a better directivity at 28 GHz, and the antenna module 10 has better communication effect at 28 GHz.

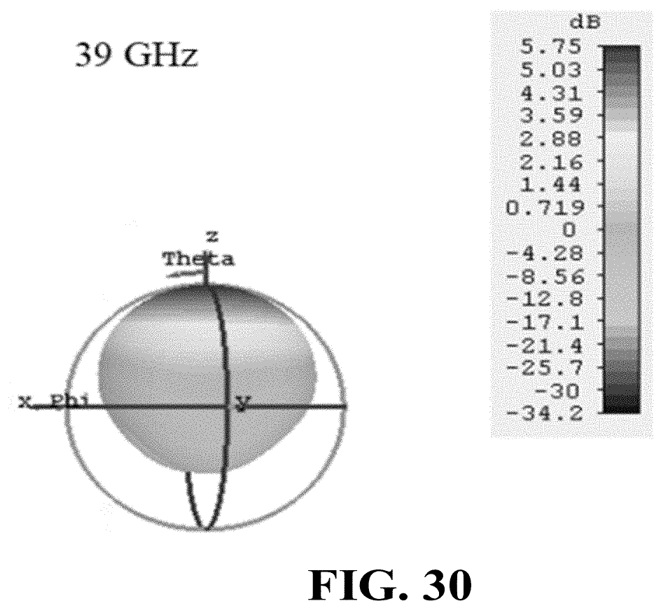

Illustrations can be made to FIG. 30, which is a directional simulation pattern of an antenna module at 39 GHz of the present disclosure. The maximum value of a gain is 5.75 dB, which indicates that there is a better directivity at 39 GHz, and the antenna module 10 has better communication effect at 28 GHz.

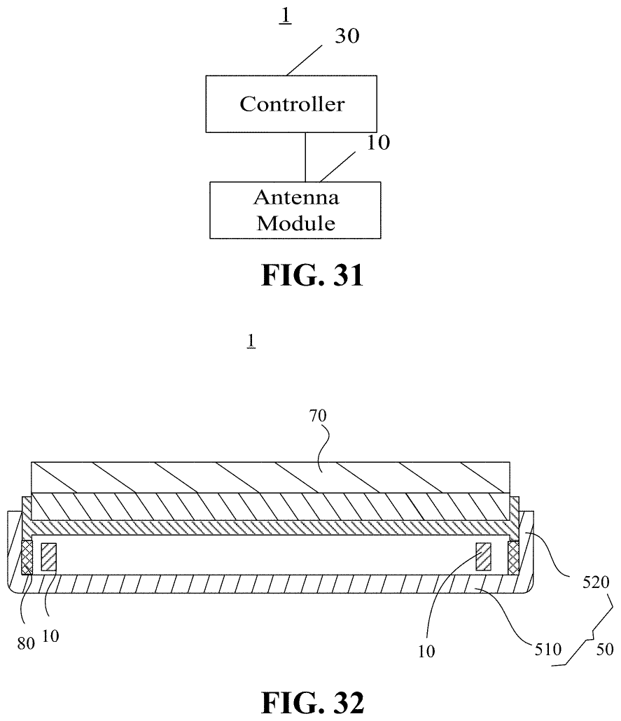

Illustrations can be made to FIG. 31, which is a circuit block diagram of an electronic device provided in an implementation of the present disclosure. The electronic device 1 may be, but is not limited to, a device with a communication function, such as a mobile phone. The electronic device 1 includes a controller 30 and the antenna module 10 described in any of the foregoing implementations. The controller 30 is electrically connected with the antenna module 10. The antenna module 10 is configured to operate under control of the controller 30. Specifically, the antenna module 10 operates under the control of the controller 30.

Illustrations can be made to FIG. 32, which is a cross-sectional view of an electronic device provided in an implementation of the present disclosure. The electronic device 1 includes a battery cover 50 and a radio-wave transparent structure 80 carried on the battery cover 50. A radiation surface of the antenna module 10 at least partially faces the battery cover 50 and the radio-wave transparent structure 80. A transmittance of the battery cover 50 to an RF signal in the first frequency band range is less than a transmittance of the battery cover 50 and the radio-wave transparent structure 80 to the RF signal in the first frequency band range. A transmittance of the battery cover 50 to an RF signal in the second frequency band range is less than a transmittance of the battery cover 50 and the radio-wave transparent structure 80 to the RF signal in the second frequency band range. The radiation surface of the antenna module 10 is a surface that radiates the RF signal in the first preset frequency band, the RF signal in the second preset frequency band, the RF signal in the third preset frequency band, and the RF signal in the fourth preset frequency band. In other words, the battery cover 50 and at least part of the radio-wave transparent structure 80 are in radiation ranges of the RF signals in the first preset frequency band, the second preset frequency band, the third preset frequency band, and the fourth preset frequency band.

The battery cover 50 is made of at least one or a combination of plastic, glass, sapphire, and ceramics. The radio-wave transparent structure 80 is carried on the battery cover 50, which includes that the radio-wave transparent structure 80 is directly disposed on an inner surface of the battery cover 50, or the radio-wave transparent structure 80 is disposed on an outer surface of the battery cover 50, or the radio-wave transparent structure 80 is embedded in the battery cover 50, or the radio-wave transparent structure 80 is attached to the inner surface or the outer surface of the battery cover 50 via a carrier film, as long as the battery cover 50 can directly or indirectly serve as a bearing substrate to carry the radio-wave transparent structure 80. In case that the radio-wave transparent structure 80 is carried on the battery cover 50 via the carrier film, the carrier film may be, but not limited to, a polyethylene terephthalate (PET) film, a flexible circuit board, a printed circuit board, and the like. The PET film can be, but not limited to, a color film, an explosion-proof film, and the like. The radio-wave transparent structure 80 is made of a conductive material, which can be metallic or non-metallic. In case that the radio-wave transparent structure 80 is made of a non-metal conductive material, the radio-wave transparent structure 80 can be transparent or non-transparent. The radio-wave transparent structure 80 may be integrated or non-integrated.

A dielectric constant of the battery cover 50 is a first dielectric constant. The battery cover 50 with the first dielectric constant has a first transmittance to the RF signal in the first frequency band range. When the radio-wave transparent structure 80 is carried on the battery cover 50, the battery cover 50 and the radio-wave transparent structure 80 as a whole has a dielectric constant of second dielectric constant, which means that the battery cover 50 and the radio-wave transparent structure 80 having the second dielectric constant has a second transmittance to the RF signal in the first frequency band range. The second transmittance is greater than the first transmittance. This implementation improves a transmittance to the RF signal in the first frequency band range by disposing the radio-wave transparent structure 80, thereby improving the communication quality when the antenna module 10 communicates by using the RF signal in the first frequency band range. Correspondingly, the battery cover 50 having the first dielectric constant has a third transmittance to the RF signal in the second frequency band range, which means that the battery cover 50 and the radio-wave transparent structure 80 having the second dielectric constant has a fourth transmittance to the RF signal in the second frequency band range. The fourth transmittance is greater than the third transmittance. This implementation improves a transmittance to the RF signal in the second frequency band range by disposing the radio-wave transparent structure 80, thereby improving the communication quality when the antenna module 10 communicates by using the RF signal in the second frequency band range.

The battery cover 50 usually includes a back plate 510 and a frame 520 bent and connected with a periphery of the back plate 510. The radio-wave transparent structure 80 is carried on the back plate 510, or the radio-wave transparent structure 80 is carried on the frame 520, or part of the radio-wave transparent structure 80 is carried on the back plate 510 and the rest of the radio-wave transparent structure 80 is carried on the frame 520. In an implementation, the antenna module 10 is implemented as one or more antenna modules, and all radiation surfaces of the antenna module 10 face the back plate 510 and the radio-wave transparent structure 80 is at least partially carried on the back plate 510. In another implementation, the antenna module 10 is implemented as one or more antenna modules, and all radiation surfaces of the antenna module 10 face the frame 520 and the radio-wave transparent structure 80 is at least partially carried on the frame 520. In another implementation, when the antenna module 10 is implemented as multiple antenna modules, radiation surfaces of some antenna modules 10 face the back plate 510, and radiation surfaces of the rest antenna modules 10 face the frame 520. Correspondingly, part of the radio-wave transparent structure 80 is carried on the back plate 510, and the rest of the radio-wave transparent structure 80 is carried on the frame 520. In the schematic view of this implementation, for example, the radiation surfaces of the antenna module 10 face the frame 520, the whole the radio-wave transparent structure 80 is carried on the frame 520, and the antenna module 10 is implemented as two antenna modules. It should be noted that, when the radiation surface of the antenna module 10 faces the back plate 510 and the radio-wave transparent structure 80 is at least partially carried on the back plate 510, the back plate 510 and the radio-wave transparent structure 80 are in the radiation ranges of the RF signals in the first preset frequency band, the second preset frequency band, the third preset frequency band, and the fourth preset frequency band. When the radiation surface of the antenna module 10 faces the frame 520 and the radio-wave transparent structure 80 is at least partially carried on the frame 520, the frame 520 and the radio-wave transparent structure 80 are within the radiation ranges of the RF signals in the first preset frequency band, the second preset frequency band, the third preset frequency band, and the fourth preset frequency band.

The radio-wave transparent structure 80 is carried on the back plate 510, which includes that the radio-wave transparent structure 80 is directly disposed on an inner surface of the back plate 510, or the radio-wave transparent structure 80 is disposed on an outer surface of the back plate 510, or the radio-wave transparent structure 80 is at least partially embedded in the back plate 510, or the radio-wave transparent structure 80 is attached to the inner surface or the outer surface of the back plate 510 via a carrier film, as long as the back plate 510 can directly or indirectly serve as a bearing substrate to carry the radio-wave transparent structure 80.

The radio-wave transparent structure 80 is carried on the frame 520, which includes that the radio-wave transparent structure 80 is directly disposed on an inner surface of the frame 520, or the radio-wave transparent structure 80 is disposed on an outer surface of the frame 520, or the radio-wave transparent structure 80 is at least partially embedded in the frame 520, or the radio-wave transparent structure 80 is attached to the inner surface or the outer surface of the frame 520 via a carrier film, as long as the frame 520 can directly or indirectly serve as a bearing substrate to carry the radio-wave transparent structure 80.

Furthermore, the electronic device 1 in this implementation further includes a screen 70. The screen 70 is disposed at an opening of the battery cover 50. The screen 70 is configured to display texts, images, and videos, etc.

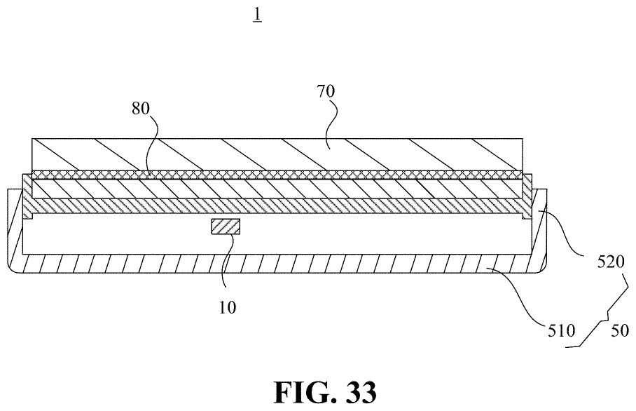

Illustrations can be made to FIG. 33, which is a cross-sectional view of an electronic device provided in another implementation of the present disclosure. The electronic device includes a screen 70 and a radio-wave transparent structure 80 carried on the screen 70. A radiation surface of the antenna module 10 at least partially faces the screen 70 and the radio-wave transparent structure 80. A transmittance of the screen 70 to an RF signal in the first frequency band range is less than a transmittance of the screen 70 and the radio-wave transparent structure 80 to the RF signal in the first frequency band range. A transmittance of the screen 70 to an RF signal in the second frequency band range is less than a transmittance of the screen 70 and the radio-wave transparent structure 80 to the RF signal in the second frequency band range. In this implementation, the radiation surface of the antenna module 10 is a surface that radiates the RF signal in the first preset frequency band, the RF signal in the second preset frequency band, the RF signal in the third preset frequency band, and the RF signal in the fourth preset frequency band. In other words, the screen 70 and at least part of the radio-wave transparent structure 80 are in the radiation ranges of the RF signals in the first preset frequency band, the second preset frequency band, the third preset frequency band, and the fourth preset frequency band.

The screen 70 may be, but is not limited to, a liquid crystal display (LCD) or an organic light emitting diode (OLED) display.

The radio-wave transparent structure 80 is carried on the screen 70, which includes that the radio-wave transparent structure 80 is directly disposed on an inner surface of the screen 70, or the radio-wave transparent structure 80 is disposed on an outer surface of the screen 70, or the radio-wave transparent structure 80 is at least partially embedded in the screen 70, or the radio-wave transparent structure 80 is attached to the inner surface or the outer surface of the screen 70 via a carrier film, as long as the screen 70 can directly or indirectly serve as a bearing substrate to carry the radio-wave transparent structure 80. When the radio-wave transparent structure 80 is carried on the screen 70 via the carrier film, the carrier film may be, but not limited to, a PET film, a flexible circuit board, a printed circuit board, and the like. The PET film can be, but not limited to, a color film, an explosion-proof film, and the like. The radio-wave transparent structure 80 is made of a conductive material, which can be metallic or non-metallic. In case that the radio-wave transparent structure 80 is made of a non-metal conductive material, the radio-wave transparent structure 80 can be transparent or non-transparent. The radio-wave transparent structure 80 may be integrated or non-integrated.

A dielectric constant of the screen 70 is a third dielectric constant. The screen 70 with the third dielectric constant has a fifth transmittance to the RF signal in the first frequency band range. When the radio-wave transparent structure 80 is carried on the screen 70, the screen 70 and the radio-wave transparent structure 80 as a whole has a dielectric constant of fourth dielectric constant, which means that the screen 70 and the radio-wave transparent structure 80 having the fourth dielectric constant has a sixth transmittance to the RF signal in the first frequency band range. The sixth transmittance is greater than the fifth transmittance. This implementation improves a transmittance to the RF signal in the first frequency band range by disposing the radio-wave transparent structure 80, thereby improving the communication quality when the antenna module 10 communicates by using the RF signal in the first frequency band range. Correspondingly, the screen 70 having the third dielectric constant has a seventh transmittance to the RF signal in the second frequency band range, which means that the screen 70 and the radio-wave transparent structure 80 having the fourth dielectric constant has an eighth transmittance to the RF signal in the second frequency band range. The eighth transmittance is greater than the seventh transmittance. This implementation improves a transmittance to the RF signal in the second frequency band range by disposing the radio-wave transparent structure 80, thereby improving the communication quality when the antenna module 10 communicates by using the RF signal in the second frequency band range. Further, the electronic device 1 further includes a battery cover 50. The screen 70 is disposed at an opening of the battery cover 50. The battery cover 50 generally includes a back plate 510 and a frame 520 bent and connected with a periphery of the back plate 510.

It should be noted that, the “first” and “second” used in “the first dielectric constant” and “the second dielectric constant” of the present disclosure are only for name distinction in dielectric constants, rather than representing a value comparison between dielectric constants, and so on. Similarly, the “first”, “second”, and the like used in others of the present disclosure are only for name distinction.

Although the implementations of the present disclosure have been shown and described above, it can be understood that the above implementations are exemplary and cannot be understood as limitations to the present disclosure. Those of ordinary skill in the art can change, amend, replace, and modify the above implementations within the scope of the present disclosure, and these modifications and improvements are also regarded as the protection scope of the present disclosure.

What is claimed is:

1. An antenna module, comprising:
a first antenna radiator configured to generate a first resonance in a first frequency band range;
a first parasitic radiator stacked with and spaced apart from the first antenna radiator, the first parasitic radiator being capable of coupling with the first antenna radiator to generate a second resonance in the first frequency band range;
a second antenna radiator stacked with and spaced apart from the first antenna radiator at a side of the first antenna radiator away from the first parasitic radiator, the second antenna radiator being configured to generate a first resonance in a second frequency band range; and
a second parasitic radiator stacked with and spaced apart from the second antenna radiator or disposed at a same layer as and spaced apart from the second antenna radiator, the second parasitic radiator being capable of coupling with the second antenna radiator to generate a second resonance in the second frequency band range, and the second frequency band range being at least partially not overlapped with the first frequency band range.

2. The antenna module of claim 1, wherein the first resonance of the first antenna radiator in the first frequency band range is used to generate a radio frequency (RF) signal in a first preset frequency band, the second resonance of the first parasitic radiator in the first frequency band range is used to generate an RF signal in a second preset frequency band, wherein the first preset frequency band and the second preset frequency band are in the first frequency band range, and the first preset frequency band is at least partially different from the second preset frequency band.

3. The antenna module of claim 1, further comprises an RF chip, wherein the first antenna radiator is between the RF chip and the first parasitic radiator, the first antenna radiator and the first parasitic radiator are conductive patches, and the first antenna radiator is electrically connected with the RF chip.

4. The antenna module of claim 3, wherein a size of the first antenna radiator is larger than a size of the first parasitic radiator, and an orthographic projection of the first parasitic radiator on a plane where the first antenna radiator is located is at least partially overlapped with a region where the first antenna radiator is located.

5. The antenna module of claim 4, wherein the orthographic projection of the first parasitic radiator on the plane where the first antenna radiator is located falls into the region where the first antenna radiator is located.

6. The antenna module of claim 3, further comprising a feeder, wherein the second antenna radiator defines a through hole therein, and the feeder extends through the through hole and electrically connects the RF chip with the first antenna radiator.

7. The antenna module of claim 3, wherein
the first antenna radiator defines a first hollow structure penetrating two opposite surfaces of the first antenna radiator; and
a size of the first antenna radiator is larger than or equal to a size of the first parasitic radiator, and a size difference between the first antenna radiator and the first parasitic radiator increases as an area of the first hollow structure increases.

8. The antenna module of claim 3, wherein the first antenna radiator defines a first hollow structure penetrating two opposite surfaces of the first antenna radiator, the first parasitic radiator defines a second hollow structure penetrating two opposite surfaces of the first parasitic radiator, a size of the first antenna radiator is larger than or equal to a size of the first parasitic radiator, and an area of the first hollow structure is larger than an area of the second hollow structure.

9. The antenna module of claim 3, wherein
the second antenna radiator is electrically connected with the RF chip, and the second antenna radiator and the second parasitic radiator are conductive patches; and
the second antenna radiator is closer to the RF chip than the second parasitic radiator in case that the second parasitic radiator is stacked with and spaced apart from the second antenna radiator.

10. The antenna module of claim 9, wherein the first antenna radiator and the second antenna radiator are conductive patches, the second antenna radiator is closer to the RF chip than the first antenna radiator, and a frequency of an RF signal in the second frequency band range is lower than a frequency of an RF signal in the first frequency band range.

11. The antenna module of claim 1, wherein the second parasitic radiator is implemented as a plurality of second parasitic radiators, and a center of a region where the second antenna radiator is located coincides with a center of an orthogonal projection of the plurality of second parasitic radiators on a plane where the second antenna radiator is located.

12. The antenna module of claim 1, wherein the second parasitic radiator is a rectangular conductive patch and has a first side and a second side connected with the first side, the first side is closer to the second parasitic radiator than the second side, and wherein a length of the first side is larger than a length of the second side, the first side is used to adjust a resonant frequency of the second parasitic radiator, and the second side is used to adjust an impedance between the second parasitic radiator and the second antenna radiator.

13. The antenna module of claim 1, wherein the first resonance of the second antenna radiator in the second frequency band range is used to generate an RF signal in a third preset frequency band, and the second resonance of the second parasitic radiator in the second frequency band range is used to generate an RF signal in a fourth preset frequency band, and wherein the third preset frequency band and the fourth preset frequency band are in the second frequency band range, and the third preset frequency band is at least partially different from the fourth preset frequency band.

14. The antenna module of claim 1, wherein
the first antenna radiator is a square conductive patch and has a side length ranged from 1.6 mm to 2.0 mm; and
the first parasitic radiator is a rectangular conductive patch, wherein a length of a long side of the first parasitic radiator is equal to the side length of the first antenna radiator, a length of a short side of the first parasitic radiator ranges from 0.2 mm to 0.9 mm, and a distance between the first parasitic radiator and the first antenna radiator ranges from 0 to 0.8 mm.

15. The antenna module of claim 1, wherein
the second antenna radiator is a square conductive patch and has a side length ranged from 2.0 mm to 2.8 mm; and
the second parasitic radiator is a rectangular conducive patch, wherein a length of a long side of the second parasitic radiator is equal to the side length of the second antenna radiator, a length of a short side of the second parasitic radiator ranges from 0.2 mm to 0.9 mm, and a distance between the second parasitic radiator to the second antenna radiator ranges from 0 to 0.6 mm.

16. The antenna module of claim 15, wherein a gap between a projection of the second parasitic radiator on a plane where the second antenna radiator is located and a region where the second antenna radiator is located ranges from 0.2 mm to 0.8 mm.

17. The antenna module of claim 1, wherein
the first frequency band range comprises millimeter wave (mmwave) 39 GHz frequency band, and the first resonance and the second resonance in the first frequency band range cover frequency band n260; and
the second frequency band range comprises 28 GHz frequency band, and the first resonance and the second resonance in the second frequency band range cover mmwave frequency bands n257, n258, and n261.

18. An electronic device, comprising:
a controller; and
an antenna module, comprising
a first antenna radiator configured to generate a first resonance in a first frequency band range;
a first parasitic radiator stacked with and spaced apart from the first antenna radiator, the first parasitic radiator being capable of coupling with the first antenna radiator to generate a second resonance in the first frequency band range;
a second antenna radiator stacked with and spaced apart from the first antenna radiator at a side of the first antenna radiator away from the first parasitic radiator, the second antenna radiator being configured to generate a first resonance in a second frequency band range; and
a second parasitic radiator stacked with and spaced apart from the second antenna radiator or disposed at a same layer as and spaced apart from the second antenna radiator, the second parasitic radiator being capable of coupling with the second antenna radiator to generate a second resonance in the second frequency band range, and the second frequency band range being at least partially not overlapped with the first frequency band range;
wherein the controller is electrically connected with the antenna module, and the antenna module is configured to operate under control of the controller.

19. The electronic device of claim 18, comprising a battery cover and a radio-wave transparent structure carried on the battery cover, a radiation surface of the antenna module at least partially faces the battery cover and the radio-wave transparent structure, a transmittance of the battery cover to an RF signal in the first frequency band range being less than a transmittance of the battery cover and the radio-wave transparent structure to the RF signal in the first frequency band range, and a transmittance of the battery cover to an RF signal in the second frequency band range being less than a transmittance of the battery cover and the radio-wave transparent structure to the RF signal in the second frequency band range.

20. The electronic device of claim 18, comprising a screen and a radio-wave transparent structure carried on the screen, a radiation surface of the antenna module at least partially faces the screen and the radio-wave transparent structure, a transmittance of the screen to an RF signal in the first frequency band range being less than a transmittance of the screen and the radio-wave transparent structure to the RF signal in the first frequency band range, and a transmittance of the screen to an RF signal in the second frequency band range being less than a transmittance of the screen and the radio-wave transparent structure to the RF signal in the second frequency band range.
